(19) United States
(12) Patent Application Publication
(10) Pub. No.: US 2021/0189604 A1
(43) Pub. Date: Jun. 24, 2021

(54) POLY(ACRYLONITRILE-CO-METHYL ACRYLATE) COMPOSITIONS INCLUDING A HINDERED AMINE LIGHT STABILIZER AND METHODS OF MAKING AND USING THE SAME

(71) Applicant: Glen Raven, Inc., Glen Raven, NC (US)

(72) Inventor: David Buffington, Elon, NC (US)

(21) Appl. No.: 17/126,644

(22) Filed: Dec. 18, 2020

Related U.S. Application Data
(60) Provisional application No. 62/951,482, filed on Dec. 20, 2019.

(51) Int. Cl. D01F 6/18; C08K 5/00; C08K 5/3435; C08K 5/357; C08K 5/3492; B29C 48/00; B29C 48/05

(52) U.S. Cl. CPC D01F 6/18; C08K 5/005; C08K 5/3435; C08K 5/357; B29K 2079/00; C08K 5/0041; B29C 48/022; B29C 48/05; C08K 5/34926

(57) ABSTRACT

Poly(acrylonitrile-co-methyl acrylate) compositions comprising a hindered amine light stabilizer are described herein. A poly(acrylonitrile-co-methyl acrylate) composition may be in the form of a fiber, thread, yarn, and/or fabric. Also described herein are methods of making and using the poly(acrylonitrile-co-methyl acrylate) compositions and articles comprising poly(acrylonitrile-co-methyl acrylate) compositions as described herein.

### RELATED APPLICATION(S)

The present application claims priority to and the benefit of U.S. Provisional Patent Application Ser. No. 62/951,482, filed Dec. 20, 2019, the disclosure of which is hereby incorporated herein in its entirety.

### FIELD

The present invention relates to poly(acrylonitrile-co-methyl acrylate) compositions that include a hindered amine light stabilizer (HALS). The present invention also relates to methods of making and using poly(acrylonitrile-co-methyl acrylate) compositions including a HALS.

### BACKGROUND

Acrylic fibers are ideally suited for use in many outdoor textile applications. Fabrics made from acrylic fibers are highly UV-resistant and can be solution-dyed to provide excellent color stability. These properties create textile goods optimized for many applications in outdoor environments such as shade structures, awnings, marine covers and outdoor furniture.

In contrast to other fibers and fabrics made from materials such as polypropylene, polyethylene, polyester, nylon and polyvinylchloride, fibers and fabrics made from acrylics are known to be the most weatherable even though formulated without UV light stabilizers.

### SUMMARY

A first aspect of the present invention is directed to an acrylic composition comprising: a poly(acrylonitrile-co-methyl acrylate) having acrylonitrile units present in an amount of at least 85% by weight of the polymer; and a hindered amine light stabilizer, wherein the hindered amine light stabilizer is within the acrylic composition. In some embodiments, the acrylic composition is an acrylic fiber.

Another aspect of the present invention is directed to a method of preparing an acrylic composition, the method comprising: combining a hindered amine light stabilizer and a poly(acrylonitrile-co-methyl acrylate) to provide a stabilized poly(acrylonitrile-co-methyl acrylate) composition. In some embodiments, the method comprises forming an acrylic fiber from the stabilized poly(acrylonitrile-co-methyl acrylate) composition. In some embodiments, forming the acrylic fiber comprises spinning (e.g., wet or dry spinning) and/or extruding the stabilized poly(acrylonitrile-co-methyl acrylate) composition.

A further aspect of the present invention is directed to an article comprising an acrylic composition of the present invention and/or an acrylic fiber prepared according to a method of the present invention. In some embodiments, the article is a fabric (e.g., an outdoor fabric and/or an automotive interior fabric), shade structure, awning, marine cover, sail (e.g., boat sail), furniture item (e.g., chair, couch, outdoor furniture item, etc.), boat, car, etc.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 shows a chemical structure of a poly(acrylonitrile-co-methyl acrylate) that may be present in an acrylic composition and/or used to prepare an acrylic composition according to example embodiments of the present invention.

FIG. 2 is a schematic diagram overview of an acrylic process according to example embodiments of the present invention.

FIG. 3 is a schematic diagram of a wet spinning process according to example embodiments of the present invention.

FIG. 4 is a schematic diagram of a dry spinning process according to example embodiments of the present invention.

FIG. 5A is a schematic diagram of part of a system for adding a hindered amine light stabilizer to a poly(acrylonitrile-co-methyl acrylate) showing a schematic of a tote or master line used to contain and/or transport a hindered amine light stabilizer according to example embodiments of the present invention.

FIG. 5B is a schematic diagram of part of a system that may be used with the system of FIG. 5A to add a hindered amine light stabilizer to a poly(acrylonitrile-co-methyl acrylate) according to example embodiments of the present invention.

FIG. 6 is a schematic diagram of a system for adding a hindered amine light stabilizer to a poly(acrylonitrile-co-methyl acrylate) during preparation of a dope according to example embodiments of the present invention.

FIG. 7 is a photograph showing a composition comprising Chimassorb® 944 (left container) compared to a composition including Tinuvin® 622 (right container).

FIG. 8 is a graph comparing the overall tear strength of the treated and control samples of Example 3.

FIG. 9 is a graph comparing the loss of tear strength of the treated and control samples of Example 3.

### DETAILED DESCRIPTION OF EXAMPLE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety. In case of a conflict in terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps “and those that do not materially affect the basic and novel characteristic(s)” of the claimed invention. See, In re Herz, 537 F.2d 549, 551-52, 190 U.S.P.Q. 461, 463 (CCPA 1976) (emphasis in the original); see also MPEP § 2111.03. Thus, the term “consisting essentially of” as used herein should not be interpreted as equivalent to “comprising.”

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measureable value may include any other range and/or individual value therein.

As used herein, the terms “increase,” “increases,” “increased,” “increasing,” and similar terms indicate an elevation in the specified parameter or value of at least about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 300%, 400%, 500% or more.

As used herein, the terms “reduce,” “reduces,” “reduced,” “reduction,” “inhibit,” and similar terms refer to a decrease in the specified parameter or value of at least about 5%, 10%, 15%, 20%, 25%, 30%, 35%, 40%, 45%, 50%, 55%, 60%, 65%, 70%, 75%, 80%, 85%, 90%, 95%, 97%, or 100%.

Provided according to embodiments of the present invention are acrylic compositions. An acrylic composition of the present invention comprises a poly(acrylonitrile-co-methyl acrylate) and a hindered amine light stabilizer. Poly(acrylonitrile-co-methyl acrylate) is an acrylonitrile polymer that can have acrylonitrile units present in an amount of at least 85% by weight of the polymer. In some embodiments, a poly(acrylonitrile-co-methyl acrylate) of the present invention includes about 85%, 86%, 87%, 88%, 89%, 90%, 91%, 92%, 93%, 94%, 95%, 96%, 97%, 98%, 99%, or 100% acrylonitrile units by weight of the polymer. In some embodiments, a poly(acrylonitrile-co-methyl acrylate) comprises acrylonitrile units in an amount of at least 85% to about 100% by weight of the polymer. In some embodiments, an acrylic composition of the present invention does not include polymethyl methacrylate (PMMA).

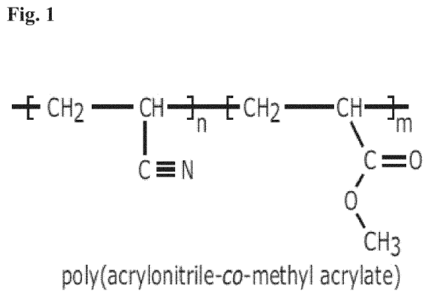

A poly(acrylonitrile-co-methyl acrylate) (P(AN-MA)) of the present invention may be a random copolymer, alternate copolymer, block copolymer, and/or graft copolymer. In some embodiments, the poly(acrylonitrile-co-methyl acrylate) may be a random copolymer. In some embodiments, a poly(acrylonitrile-co-methyl acrylate) of the present invention comprises one or more acrylonitrile unit(s) having a structure of —(CH₂CH(CN))ₙ— and one or more methyl acrylate unit(s) having a structure of —(CH₂—CH(C(O)OCH₃))ₘ—, wherein n and m each represent the weight percentage of the unit in the polymer and n is 0.85 to 0.99 and m is 0.01 to 0.15. In some embodiments, a poly(acrylonitrile-co-methyl acrylate) may comprise a structure and/or one or more units as shown in FIG. 1, where n is 0.85 to 0.99 and m is 0.01 to 0.15.

A poly(acrylonitrile-co-methyl acrylate) may comprise methyl acrylate unit(s), having a structure of —(CH₂—CH(C(O)OCH₃))— in an amount of about 0.01%, 0.05%, 0.1%, 0.5%, 1%, 2%, 3%, 4%, 5%, 6%, 7%, 8%, 9%, 10%, 11%, 12%, 13%, 14%, or 15% by weight of the polymer. In some embodiments, a poly(acrylonitrile-co-methyl acrylate) comprises methyl acrylate units in an amount of about 0.1% to about 15% by weight of the polymer, such as about 1% to about 15%, about 5% to about 15%, or about 10% to about 15% by weight of the polymer.

In some embodiments, an acrylic composition of the present invention comprises or is a manufactured fiber in which the fiber-forming substance includes or is a poly(acrylonitrile-co-methyl acrylate) as defined herein. In some embodiments, a poly(acrylonitrile-co-methyl acrylate) is the primary fiber-forming substance. Thus, the acrylic composition of the present invention may also be referred to herein as a polyacrylonitrile composition. In some embodiments, an acrylic composition of the present invention is a liquid and/or a composition prior to acrylic fiber formation. A poly(acrylonitrile-co-methyl acrylate) may be present in the acrylic composition (e.g., acrylic fiber) in an amount of at least about 90%, 91%, 92%, 93%, 94%, 95%, 96%, 97%, 98%, 99%, or 100% by weight of the acrylic composition. In some embodiments, a poly(acrylonitrile-co-methyl acrylate) may be present in the acrylic composition (e.g., acrylic fiber) in an amount about 90% to about 100%, about 95% to about 99% or about 97% to about 99% by weight of the acrylic composition.

An acrylic fiber of the present invention is a manufactured fiber in which the fiber-forming substance includes or is poly(acrylonitrile-co-methyl acrylate) as defined herein and is the extrudate (e.g., solidified, dried, and/or cooled extrudate) from a fiber spinning process (e.g., a wet or dry spinning process). In some embodiments, the acrylic fiber is a wet spun acrylic fiber or a dry spun acrylic fiber. An acrylic fiber of the present invention may be in any suitable form, such as, for example, staple, tow, filament, or monofilament. Typically, an acrylic staple fiber has a length in a range from about 0.75 inches to about 18 inches, and an acrylic filament fiber has any suitable length (e.g., greater than 18 inches to about 2, 4, 6, 8, 10, 100, 200, 1,000, 10,000, or 20,000, 30,000 yards or infinite length). In some embodiments, an acrylic fiber of the present invention is not in the form of a core sheath fiber (e.g., a fiber having a material in a different concentration in the core than in the sheath) and/or a bi-component fiber.

An acrylic yarn of the present invention comprises a plurality of acrylic fibers arranged in any suitable manner. In some embodiments, an acrylic yarn may be a plurality of acrylic fibers arranged so that at least a portion (e.g., a majority) of the acrylic fibers of the plurality are parallel to each other and the plurality of acrylic fibers may be twisted. An acrylic yarn of the present invention may be in any suitable form, such as, for example, a filament yarn (i.e., a yarn made using one or more continuous acrylic fiber(s)) or a staple yarn (i.e., a yarn made using two or more staple acrylic fibers). A filament yarn is composed of a continuous filament that may be assembled with or without twist. Filament yarns composed of a single filament are called monofilaments and those of two or more filaments are called multifilaments. A spun or stable yarn is composed of staple fibers that are held together by a binding mechanism. In some embodiments, an acrylic yarn of the present invention comprises about 80%, 85%, 90%, 95%, 98%, or 100% acrylic fibers of the present invention based on the weight of the acrylic yarn or the total number of fibers in the yarn. In some embodiments, one or more properties (e.g., tensile strength, break strength, and/or flexibility) of a yarn (e.g., an acrylic yarn of the present invention) may be measured with a yarn having a 18/2 Ring Spun Cotton Count with 12.25 turns per inch in the singles yarn and 12.4 turns per inch in the ply, with the yarn optionally being prepared with 2 denier fibers having a 45 mm staple length.

An acrylic fabric of the present invention comprises a plurality of acrylic fibers and optionally a plurality of acrylic yarns. A nonwoven acrylic fabric of the present invention comprises a plurality of acrylic fibers that are bonded together, such as, e.g., through physical entanglement of the acrylic fibers, adhesive bonding of the acrylic fibers, melt bonding of the acrylic fibers, solvent bonding of the acrylic fibers, and any combination thereof. A woven acrylic fabric of the present invention comprises a plurality of acrylic yarns that are interlaced and/or intermeshed. In some embodiments, an acrylic fabric may be woven in the form of a plain weave, twill weave, leno weave, dobby weave, jacquard weave, and/or satin weave. In some embodiments, an acrylic fabric may be woven in the form of a plain weave. In some embodiments, an acrylic fabric of the present invention comprises about 80%, 85%, 90%, 95%, 98%, or 100% acrylic fibers and/or yarns of the present invention based on the weight of the fabric or the total number of fibers and/or yarns in the fabric. In some embodiments, one or more properties (e.g., CIE Delta E and/or Gray Scale value) of a fabric (e.g., an acrylic fabric of the present invention) may be measured with a plain weave 75 epi×35 ppi fabric and/or a plain weave 68 epi×30 ppi fabric, with the fabric optionally being prepared with a yarn having a 18/2 Ring Spun Cotton Count with 12.25 turns per inch in the singles yarn and 12.4 turns per inch in the ply, with the yarn optionally being prepared with 2 denier fibers having a 45 mm staple length.

In some embodiments, a poly(acrylonitrile-co-methyl acrylate) comprises one or more (e.g., 1, 2, 3, 4, 5, or more) additional comonomer unit(s) (e.g., a neutral and/or acid comonomer unit and/or terminal group). An additional comonomer may be present in the polymer in an amount of about 0.01%, 0.05%, 0.1%, 0.5%, 1%, 2%, 3%, 4%, or 5% by weight of the polymer. In some embodiments, a poly(acrylonitrile-co-methyl acrylate) comprises one or more additional comonomer units in an amount of about 0% to about 5%, about 0.01% to about 2%, about 0.1% to about 0.5%, or about 0.1% to about 1% by weight of the polymer. Examples of comonomer units that may be included in addition to a methyl acrylate unit include, but are not limited to, vinyl acetate, vinyl chloride, vinylidene chloride, styrene, methyl methacrylate, vinyl acetate, sodium styrene sulfonate, sodium methallyl sulfonate, sodium sulfophenyl methallyl, ether, and/or itaconic acid. In some embodiments, an acrylic composition of the present invention is devoid of vinyl acetate (e.g., a comonomer unit of vinyl acetate) and/or devoid of poly(acrylonitrile-co-vinyl acetate).

As those skilled in the art will understand, a poly(acrylonitrile-co-methyl acrylate) may be obtained by polymerizing an acrylonitrile monomer and a methyl acrylate monomer, optionally in the presence of one or more additional comonomers. In some embodiments, a poly(acrylonitrile-co-methyl acrylate) that may be present in and/or used to prepare an acrylic composition of the present invention may comprise acrylonitrile units in an amount of about 90% to about 94% by weight of the polymer and methyl acrylate units in an amount of about 6% to about 10% by weight of the polymer. In some embodiments, the comonomer units may comprise methyl acrylate units in an amount of about 6% to about 9% by weight of the polymer and acid comonomer units in an amount of about 0% to about 1% by weight of the polymer. In some embodiments, a poly(acrylonitrile-co-methyl acrylate) that may be present in and/or used to prepare an acrylic composition of the present invention may comprise acrylonitrile units in an amount of about 90% to about 94% by weight of the polymer, methyl acrylate units in an amount of about 6% to about 9% by weight of the polymer, and optionally acid comonomer units in an amount of about 0% to about 1% by weight of the polymer. Exemplary acid comonomers include, but are not limited to, sodium styrene sulfonate, sodium methallyl sulfonate, sodium sulfophenyl methallyl ether, and/or itaconic acid.

An acrylic composition of the present invention may comprise one or more (e.g., 1, 2, 3, 4, 5, or more) additional acrylonitrile polymer(s), optionally in an amount of about 10% or less by weight of the acrylic composition. In some embodiments, the acrylic composition may comprise a blend of a poly(acrylonitrile-co-methyl acrylate) and a polyacrylonitrile homopolymer and/or a polyacrylonitrile copolymer that is different than poly(acrylonitrile-co-methyl acrylate). In some embodiments, the acrylic composition may comprise a blend of at least two different polyacrylonitrile polymers. A blend of a poly(acrylonitrile-co-methyl acrylate) and an additional acrylonitrile polymer that is different than P(AN-MA) may comprise the additional acrylonitrile polymer in an amount of about 0.1%, 0.5%, 1%, 2%, 3%, 4%, 5%, 6%, 7%, 8%, 9%, or 10% based on the total amount of all acrylonitrile polymers present in the acrylic composition.

In some embodiments, a poly(acrylonitrile-co-methyl acrylate) may have an average molecular weight in a range from about 40,000 g/mol to about 200,000 g/mol or about 90,000 g/mol to about 170,000. In some embodiments, a poly(acrylonitrile-co-methyl acrylate) may have an average molecular weight of about 40,000, 50,000, 60,000, 70,000, 80,000, 90,000, 100,000, 110,000, 120,000, 130,000, 140,000, 150,000, 160,000, 170,000, 180,000, 190,000, or 200,000 g/mol.

A “hindered amine light stabilizer” as used herein refers to a compound or polymer comprising a substituted piperidinyl group. In some embodiments, the substituted piperidinyl group may comprise 1, 2, 3, 4, 5, 6, 7, 8, or more substituents, such as, e.g., an alkyl, alkenyl, or alkoxy group. In some embodiments, the substituted piperidinyl group comprises 1 or 2 substituents (e.g., a C1-C20 alkyl or C1-C20 alkenyl group) at the 2- and/or 6-position of the piperidine ring. In some embodiments, the substituted piperidinyl group is a 2,2,6,6-tetraalkylpiperidinyl group (e.g., a 2,2,6,6-tetramethylpiperidinyl group). In some embodiments, the substituted piperidinyl group comprises hydrogen, an alkyl group or an alkoxy group at the 1-position of the piperidine ring. In some embodiments, the substituted piperidinyl group comprises hydrogen at the 1-position of the piperidine ring. In some embodiments, a hindered amine light stabilizer comprises an amine group that acts through and/or participates in a regenerative free radical scavenging mechanism. In some embodiments, a hindered amine light stabilizer of the present invention is a UV stabilizer.

One or more (e.g., 1, 2, 3, 4, 5, or more) substituted piperidinyl group(s) may be present in a hindered amine light stabilizer. In some embodiments, the hindered amine light stabilizer is a polymer and comprises one or more (e.g., 1, 2, 3, 4, 5, or more) substituted piperidinyl group(s) per repeating unit of the hindered amine light stabilizer. In some embodiments, an acrylic composition of the present invention may comprise a hindered amine light stabilizer that comprises one or more (e.g., 1, 2, 3, 4, or more) 2,2,6,6-tetraalkylpiperidinyl group(s) in the hindered amine light stabilizer. In some embodiments, the hindered amine light stabilizer may be a polymeric or oligomeric hindered amine light stabilizer, and may comprise one or more (e.g., 1, 2, 3, 4, or more) 2,2,6,6-tetraalkylpiperidinyl group(s) per repeating unit of the hindered amine light stabilizer. In some embodiments, the hindered amine light stabilizer comprises one or more unit(s) of Formula A:

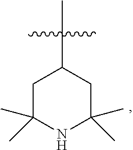

optionally wherein the hindered amine light stabilizer comprises one or more unit(s) (e.g., 1, 2, 3, 4 or more) of Formula A per repeating unit of the hindered amine light stabilizer. In some embodiments, a hindered amine light stabilizer comprises 2 units of Formula A per repeating unit of the hindered amine light stabilizer. In some embodiments, a hindered amine light stabilizer comprises 3 units of Formula A per repeating unit of the hindered amine light stabilizer.

In some embodiments, a hindered amine light stabilizer is present in an acrylic composition of the present invention in an amount in a range of about 0.01%, 0.5%, or 1% to about 2%, 3% or 10% by weight of the acrylic composition (e.g., acrylic fiber). In some embodiments, a hindered amine light stabilizer is present in an acrylic composition of the present invention in an amount of about 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.25%, 1.5%, 1.75%, 2%, 2.25%, 2.5%, 2.75%, 3%, 3.25%, 3.5%, 3.75%, 4%, 4.25%, 4.5%, 4.75%, 5%, 5.25%, 5.5%, 5.75%, 6%, 6.25%, 6.5%, 6.75%, 7%, 7.25%, 7.5%, 7.75%, 8%, 8.25%, 8.5%, 8.75%, 9%, 9.25%, 9.5%, 9.75%, or 10% by weight of the acrylic composition. In some embodiments, one or more (e.g., 1, 2, 3, 4, 5, or more) different hindered amine light stabilizer(s) may be present in the acrylic composition. In some embodiments, a hindered amine light stabilizer may scavenge, bind, trap, and/or remove one or more free radical(s) present in the acrylic composition.

Example hindered amine light stabilizers include, but are not limited to, those under the tradename Tinuvin® commercially available from BASF, such as, e.g., Tinuvin® PA 123, Tinuvin® 371, Tinuvin® 111 and/or Tinuvin® 622; those under the tradename Chimassorb® commercially available from BASF, such as, e.g., Chimassorb® 2020, Chimassorb® 944, and/or Chimassorb® 119; those under the tradename Uvasorb® commercially available from 3V Sigma USA, such as, e.g., Uvasorb® HA88FD and/or Uvasorb® HA10, and/or those under the tradename Cyasorb® commercially available from Cytec Industries, Inc., such as, e.g., Cyasorb® UV-3529. The chemical structure of such hindered amine light stabilizers and/or additional exemplary hindered amine light stabilizers include, but are not limited to, those described in U.S. Patent Application Publication No. 2003/0199618.

A hindered amine light stabilizer may have a pKa in a range from about 2, 2.5, 3, 3.5, 4, 4.5, 5, 5.5, 6, 6.5, 7, 7.5, 8, 8.5, or 9 to about 9.5, 10, 10.5, or 11. In some embodiments, a hindered amine light stabilizer may have a pKa of about 2, 2.5, 3, 3.5, 4, 4.5, 5, 5.5, 6, 6.5, 7, 7.2, 7.4, 7.5, 7.6, 7.8, 8, 8.2, 8.4, 8.5, 8.6, 8.8, 9, 9.2, 9.4, 9.5, 9.6, 9.8, 10, 10.2, 10.4, 10.5, 10.6, 10.8, or 11. In some embodiments, the hindered amine light stabilizer has a pKa in a range from about 2 to about 11, about 3.5 to about 4.5, about 6 to about 7 or 7.5, about 7 to about 10, about 7 to about 11, about 8 to about 11, about 8.5 to about 11, about 9 to about 11, or about 9.5 to about 11. The pKa of a hindered amine light stabilizer refers to the acid dissociation constant of the conjugate acid of the hindered amine light stabilizer.

In some embodiments, a hindered amine light stabilizer has a number average molecular weight in a range from about 500, 1000, 2000 or 3000 g/mol to about 4000, 5000, 10,000, or 20,000 g/mol. In some embodiments, a hindered amine light stabilizer has a number average molecular weight in a range from about 500 g/mol to about 5000 g/mol, about 1000 g/mol to about 4000 g/mol, about 2000 g/mol to about 3500 g/mol, or about 2000 g/mol to about 10,000 g/mol. In some embodiments, a hindered amine light stabilizer has a number average molecular weight of about 3100 g/mol or less, optionally about 1000 or 2000 g/mol to about 3000 or 3100 g/mol. In some embodiments, a hindered amine light stabilizer has a molecular weight in a range from about 500 or 700 g/mol to about 1000, 2000, or 4500 g/mol. In some embodiments, a hindered amine light stabilizer has a molecular weight of about 500, 600, 700, 800, 900, 1000, 1500, 2000, 2500, 3000, 3500, 4000, 4500, 5000, 6000, 7000, 8000, 9000, or 10,000 g/mol. In some embodiments, a hindered amine light stabilizer has a molecular weight in a range from about 500 g/mol to about 10,000 g/mol, about 1000 g/mol to about 5000 g/mol, about 2000 g/mol to about 5000 g/mol, or about 2500 g/mol to about 4000 g/mol. In some embodiments, a hindered amine light stabilizer has an average molecular weight and/or molecular weight in a range from about 1000 or 2000 g/mol to about 3500 or 4000 g/mol and a pKa in a range from about 2, 3, 4, 5, 6, 6.5, or 7 to about 7.5, 8, 8.5, 9, 9.5, 10, 10.5, or 11.

A hindered amine light stabilizer may be soluble in one or more solvents (e.g., a polar organic solvent and/or a dipolar aprotic solvent). In some embodiments, a hindered amine light stabilizer may dissolve in a solvent such as a dipolar aprotic solvent (e.g. N,N-dimethylformamide (DMF)), optionally at room temperature. In some embodiments, a hindered amine light stabilizer may have a lower solubility in water compared to its solubility in a polar organic solvent, such as, e.g., acetone, DMF, DMAc, acetonitrile, dimethylsulfoxide (DMSO), etc. In some embodiments, a hindered amine light stabilizer may have a water solubility at 20° C. of less than about 2%, 1%, 0.1%, or 0.01% w/w. In some embodiments, a hindered amine light stabilizer may be soluble in a solvent (e.g., acetone, DMF, acetonitrile, DMSO, toluene, dimethyl acetamide (DMAc), etc.) at 20° C. or room temperature in an amount of about 25%, 30%, 35%, 40%, 45%, 50%, 55%, 60%, 65%, 70%, 75%, 80%, 85%, 90%, 95%, or 100% w/w.

In some embodiments, an acrylic composition that is devoid of a pigment, that is in the form of a liquid, and that includes a poly(acrylonitrile-co-methyl acrylate) and a hindered amine light stabilizer that is dissolved in a solvent (e.g., DMF) has a color that is darker and/or orange and/or brown compared to the acrylic composition in the absence of the hindered amine light stabilizer, and an acrylic fiber prepared from the acrylic composition may have a color that is not yellow, orange and/or brown. Instead, the acrylic fiber prepared from the acrylic composition including the hindered amine light stabilizer may have a color consistent with an unpigmented acrylic fiber (e.g., ecru or natural) that lacks the hindered amine light stabilizer. In some embodiments, an acrylic composition that is devoid of a pigment, that is in the form of a liquid, and that comprises a hindered amine light stabilizer may have a color that is darker and/or more brown and/or orange than the color of the composition in the absence of the hindered amine light stabilizer. It was surprisingly discovered by the inventors of the present invention that an acrylic composition of the present invention that is devoid of a pigment, in the form of a liquid, and that includes a poly(acrylonitrile-co-methyl acrylate), a solvent and a hindered amine light stabilizer may have a color that is darker and/or more brown and/or orange than the color of the composition in the absence of the hindered amine light stabilizer and yet provide an acrylic fiber that, when devoid of a pigment, is not yellow, brown, and/or orange in color and instead has a color consistent with an unpigmented acrylic fiber that lacks the hindered amine light stabilizer. For example, an acrylic composition that is devoid of a pigment, in the form of a liquid, and comprises a poly(acrylonitrile-co-methyl acrylate), a solvent and a hindered amine light stabilizer may be amber in color, but may provide an acrylic fiber that is not yellow, brown, and/or orange in color, that has a color consistent with an unpigmented acrylic fiber lacking a hindered amine light stabilizer, and/or has a Gray scale value of about 4 to about 5 (e.g., 4, 4-5, or 5) after exposure to about 800 kJ to about 2500 kJ of light, optionally when the fiber is in the form of a fabric. It was also surprisingly discovered by the inventors of the present invention that an acrylic composition of the present invention that is devoid of a pigment, that is in the form of a liquid, and that includes a poly(acrylonitrile-co-methyl acrylate), a solvent and a hindered amine light stabilizer may be less yellow and/or have less color change than an acrylic composition that includes a poly(acrylonitrile-co-vinyl acetate), solvent and a hindered amine light stabilizer (optionally the same hindered amine light stabilizer as the poly(acrylonitrile-co-methyl acrylate) composition). In some embodiments, an acrylic fiber prepared from an acrylic composition comprising a poly(acrylonitrile-co-methyl acrylate), a solvent and a hindered amine light stabilizer may be less yellow and/or have less color change than an acrylic fiber prepared from an acrylic composition that includes a poly(acrylonitrile-co-vinyl acetate), solvent and a hindered amine light stabilizer (optionally the same hindered amine light stabilizer as the poly(acrylonitrile-co-methyl acrylate) composition). In some embodiments, an acrylic composition of the present invention that is devoid of a pigment, that is in the form of a liquid, and comprises a poly(acrylonitrile-co-methyl acrylate), a solvent and a hindered amine light stabilizer may be amber in color, but may provide an acrylic fiber that has a Gray scale value of 5 after exposure to about 100, 880, 1320, or 2200 kJ of light, optionally when the fiber when in the form of a fabric.

In some embodiments, the hindered amine light stabilizer has or comprises a structure of Formula (I), Formula (II), Formula (III), Formula (IV), Formula (V), Formula (VI), Formula (VII), or Formula (VIII):

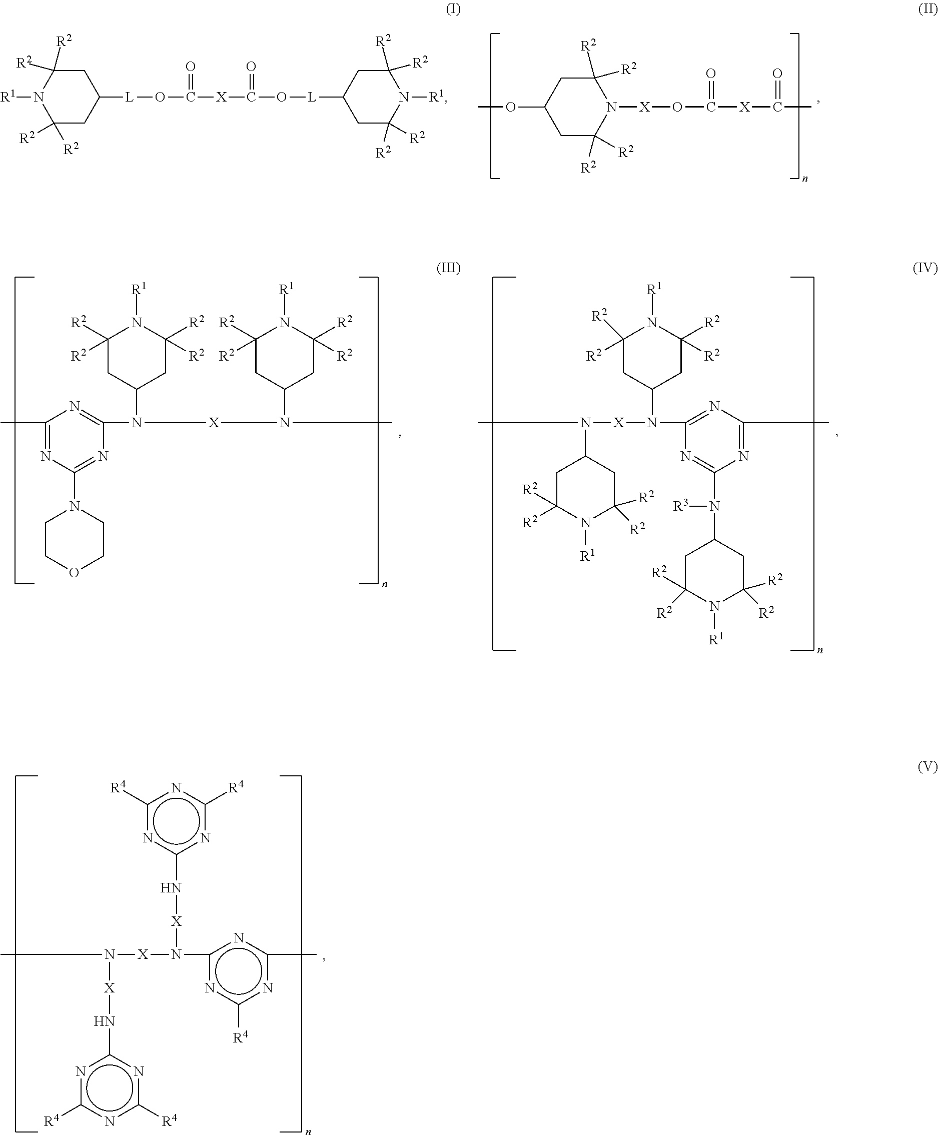

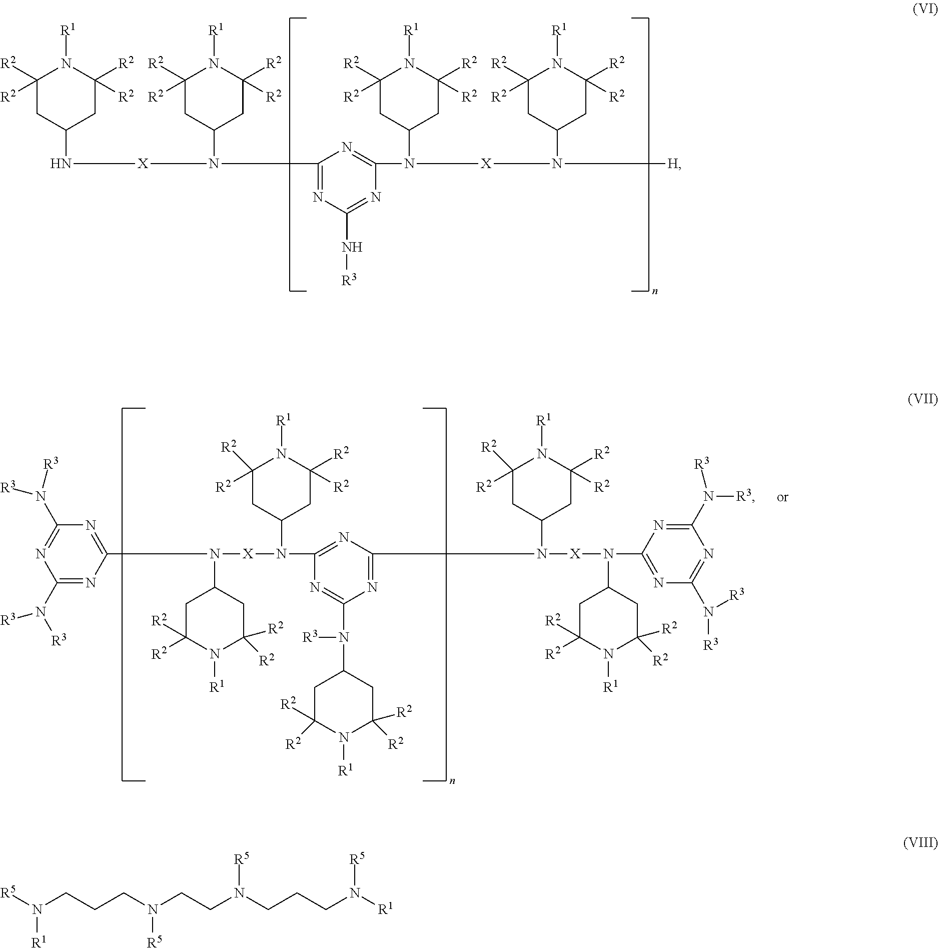

wherein:

each X is independently selected from the group consisting of C1-C20 alkyl and C1-C20 alkenyl;

L, in each instance, is absent or is independently selected from the group consisting of C1-C20 alkyl and C1-C20 alkenyl;

each R¹ is independently selected from the group consisting of hydrogen, C1-C20 alkyl, C1-C20 alkenyl, —O(C1-C20 alkyl), and —O(C1-C20 alkenyl);

each R² is independently selected from the group consisting of hydrogen, C1-C20 alkyl, and C1-C20 alkenyl;

each R³ is independently selected from the group consisting of hydrogen, C1-C20 alkyl, and C1-C20 alkenyl;

each R⁴, if present, independently has a structure of:

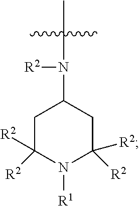

each R⁵, if present, independently has a structure of:

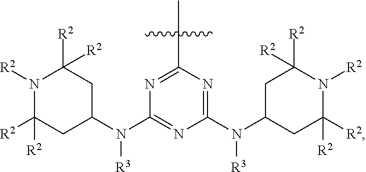

and

n is an integer selected from 1 to 1,000,000 (e.g., 1 to 100,000; 1 to 10,000; 1 to 1,000; 1 to 100; 1 to 50, or 1 to 10), and/or wherein n is an integer sufficient to provide a molecular weight (optionally a number average molecular weight) in a range of about 500, 1000, 2000 or 2500 g/mol to about 3000, 3500, 4000, 5000, 10,000, or 20,000 g/mol.

In some embodiments, in a compound of Formula (I), (II), (III), (IV), (V), (VI), (VII), or (VIII) each R¹ may independently be —O(C1-C20 alkyl) or —O(C2-C20 alkenyl), and, in some embodiments, each R¹ may independently be —O(C1-C4 alkyl) or —O(C2-C4 alkenyl). In some embodiments, in a compound of Formula (I), (II), (III), (IV), (V), (VI), (VII), or (VIII) each R¹ is hydrogen. In some embodiments, a hindered amine light stabilizer of the present invention does not comprise a halogen (e.g., a bromine, chlorine, or iodine) and/or is not halogenated. In some embodiments, a compound of Formula (I), (II), (III), (IV), (V), (VI), (VII), or (VIII) may not comprise a halogen (e.g., a bromine, chlorine, or iodine) and/or is not halogenated.

“Alkyl” or “alkyl group,” as used herein, means a straight-chain (i.e., unbranched), branched, or cyclic hydrocarbon chain that is completely saturated. In some embodiments, alkyl groups contain 1, 2, 3, 4, 5, 6, 7, 8, 9, 10, 11, 12, 13, 14, 15, 16, 17, 18, 19, or 20 carbon atoms (e.g., C1-4, C2-4, C3-4, C1-5, C2-5, C3-5, C1-6, C2-6, C3-6, C2-7, C1-8, C4-8, C4-20, C6-10, C6-20, C8-10, C8-20, etc.). In some embodiments, an alkyl group contains 1-8 carbon atoms. In some embodiments, an alkyl group contains 1-6 carbon atoms. In some embodiments, an alkyl group contains 6-20 carbon atoms. In some embodiments, an alkyl group contains 2-3 carbon atoms, and in some embodiments, an alkyl group contains 1-4 carbon atoms. In some embodiments, the term “alkyl” or “alkyl group” means a straight-chain (i.e., unbranched) or branched hydrocarbon chain that is completely saturated. In certain embodiments, the term “alkyl” or “alkyl group” refers to a cycloalkyl group, also known as carbocycle. Non-limiting examples of example alkyl groups include methyl, ethyl, propyl, isopropyl, butyl, cyclopropyl and cyclohexyl.

“Alkenyl” or “alkenyl group,” as used herein, refers to a straight-chain (i.e., unbranched), branched, or cyclic hydrocarbon chain that has one or more double bonds. In certain embodiments, an alkenyl group contains 1-20 carbon atoms. In certain embodiments, an alkenyl group contains 1-6 carbon atoms. In some embodiments, an alkenyl group contains 6-20 carbon atoms. In still other embodiments, an alkenyl group contains 1-4 carbon atoms, and in some embodiments, an alkenyl group contains 2-3 carbon atoms. In some embodiments, the term “alkenyl” or “alkenyl group” refers to a straight-chain (i.e., unbranched) or branched hydrocarbon chain that has one or more double bonds. According to some embodiments, the term alkenyl refers to a straight chain hydrocarbon having two double bonds, also referred to as “diene.” In other embodiments, the term “alkenyl” or “alkenyl group” refers to a cycloalkenyl group. Non-limiting examples of alkenyl groups include —CH═CH₂, —CH₂CH═CH₂ (also referred to as allyl), —CH═CHCH₃, —CH₂CH₂CH═CH₂, —CH₂CH═CHCH₃, —CH═CH₂CH₂CH₃, —CH═CH₂CH═CH₂, and cyclobutenyl.

In some embodiments, an acrylic composition of the present invention comprises a hindered amine light stabilizer having a structure of Formula (I). In some embodiments, in the compound of Formula (I), L may be absent or a C1-C4 alkyl; X may be a C4-C12 alkyl, C6-C10 alkyl, C4-C12 alkenyl, or C6-C10 alkenyl; each R¹ is independently a C4-C12 alkyl, C6-C10 alkyl, C4-C12 alkenyl, C6-C10 alkenyl, —O(C4-C12 alkyl), —O(C4-C12 alkenyl), —O(C6-C10 alkyl), or —O(C6-C10 alkenyl); and/or each R² is independently a C1-C4 alkyl or C2-C4 alkenyl. In some embodiments, in the compound of Formula (I), L may be absent; X may be a C6-C10 alkyl; each R¹ is independently a —O(C6-C10 alkyl); and/or each R² is independently a C1-C4 alkyl. In some embodiments, in the compound of Formula (I), L may be absent; X may be a C8 alkyl; each le is a —O(C8 alkyl); and/or each R² is a methyl group. In some embodiments, in the compound of Formula (I), each L is the same, each R¹ is the same, and/or each R² is the same.

In some embodiments, an acrylic composition of the present invention comprises a hindered amine light stabilizer having a structure of Formula (Ia):

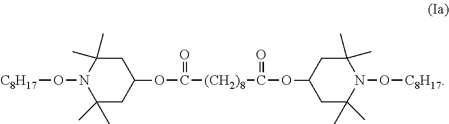

In some embodiments, an acrylic composition of the present invention comprises a hindered amine light stabilizer having a structure of Formula (II). In some embodiments, in the compound of Formula (II), each X is independently a C1-C6 alkyl, C1-C4 alkyl, C2-C6 alkenyl, or C2-C4 alkenyl; each R² is independently a C1-C4 alkyl or C2-C4 alkenyl; and/or n is 1 to 100 or 1 to 15. In some embodiments, in the compound of Formula (II), each X is independently a C1-C4 alkyl; each R² is independently a C1-C4 alkyl; and/or n is 1 to 15. In some embodiments, in the compound of Formula (II), each X is a C2 alkyl; each R² is a methyl group; and/or n is 1 to 15. In some embodiments, in the compound of Formula (II), each Xis the same and/or each R² is the same.

In some embodiments, an acrylic composition of the present invention comprises a hindered amine light stabilizer having a structure of Formula (IIa):

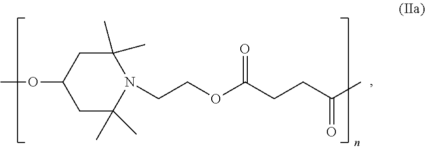

optionally wherein n is 9, 10, 11, 12, 13, or 14.

In some embodiments, an acrylic composition of the present invention comprises a hindered amine light stabilizer having a structure of Formula (III). In some embodiments, in the compound of Formula (III), X may be a C1-C10 alkyl, C1-C8 alkyl, C2-C10 alkenyl, or C2-C8 alkenyl; each R¹ is independently a C1-C6 alkyl, C1-C4 alkyl, C2-C6 alkenyl, C2-C4 alkenyl, —O(C1-C6 alkyl), —O(C2-C6 alkenyl), —O(C1-C4 alkyl), or —O(C2-C4 alkenyl); each R² is independently a C1-C4 alkyl or C2-C4 alkenyl; and/or n is 1 to 10 or 1 to 5. In some embodiments, in the compound of Formula (III), X may be a C1-C8 alkyl; each R¹ is independently a C1-C4 alkyl; each R² is independently a C1-C4 alkyl; and/or n is 1 to 5. In some embodiments, in the compound of Formula (III), X may be a C6 alkyl; each R¹ is a methyl group; each R² is a methyl group; and/or n is 1 to 5. In some embodiments, in the compound of Formula (III), each R¹ is the same and/or each R² is the same.

In some embodiments, an acrylic composition of the present invention comprises a hindered amine light stabilizer having a structure of Formula (IIIa):

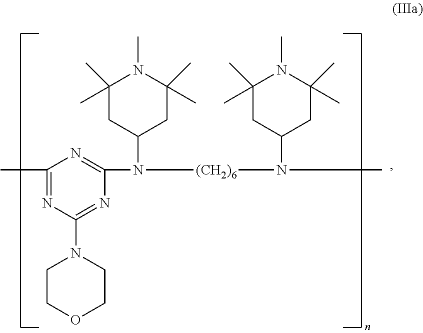

optionally wherein n is 2, 3, 4, or 5.

In some embodiments, an acrylic composition of the present invention comprises a hindered amine light stabilizer having a structure of Formula (IV). In some embodiments, in the compound of Formula (IV), X may be a C2-C12 alkyl, C2-C8 alkyl, C2-C12 alkenyl, or C2-C8 alkenyl; each R¹ is independently hydrogen, C1-C4 alkyl, C2-C4 alkenyl, —O(C1-C4 alkyl), or —O(C2-C4 alkenyl); each R² is independently a C1-C4 alkyl or C2-C4 alkenyl; R³ is a C1-C10 alkyl, C1-C8 alkyl, C2-C10 alkenyl, or C2-C8 alkenyl; and/or n is 1 to 100 or 1 to 10. In some embodiments, in the compound of Formula (IV), X may be a C2-C8 alkyl; each R¹ is independently hydrogen or a C1-C4 alkyl; each R² is independently a C1-C4 alkyl; R³ is a C1-C8 alkyl; and/or n is 1 to 10. In some embodiments, in the compound of Formula (IV), X may be a C6 alkyl; each R¹ is hydrogen; each R² is independently a methyl group; R³ is a C4 alkyl; and/or n is 1 to 10. In some embodiments, in the compound of Formula (IV), each R¹ is the same and/or each R² is the same.

In some embodiments, an acrylic composition of the present invention comprises a hindered amine light stabilizer having a structure of Formula (IVa):

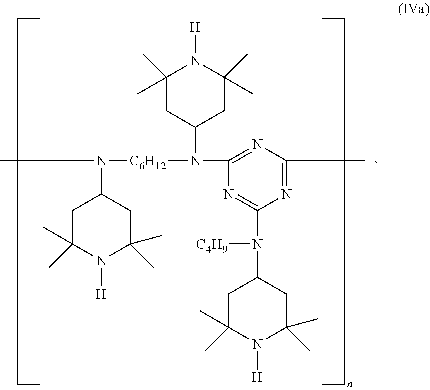

optionally wherein n is 2, 3, 4, 5, 6, 7, or 8.

In some embodiments, an acrylic composition of the present invention comprises a hindered amine light stabilizer having a structure of Formula (V). In some embodiments, in the compound of Formula (V), each X is independently a C2-C8 alkyl, C2-C4 alkyl, C2-C8 alkenyl, or C2-C4 alkenyl; each R¹ is independently hydrogen, C1-C4 alkyl, C2-C4 alkenyl, —O(C1-C4 alkyl), or —O(C2-C4 alkenyl); each R² is independently a C1-C4 alkyl or C2-C4 alkenyl; and/or n is 1 to 50, 1 to 10, or 1 to 5. In some embodiments, in the compound of Formula (V), each X is independently a C1 alkyl, C2 alkyl, C3 alkyl, or C4 alkyl; each R¹ is independently hydrogen or a C1-C4 alkyl; each R² is independently a C1-C4 alkyl; and/or n is 1 to 10 or 1 to 5. In some embodiments, in the compound of Formula (V), each X is independently a C2 alkyl or C3 alkyl; each R¹ is hydrogen; each R² is a methyl group; and/or n is 1 to 10. In some embodiments, in the compound of Formula (V), each R¹ is the same and/or each R² is the same.

In some embodiments, an acrylic composition of the present invention comprises a hindered amine light stabilizer having a structure of Formula (Va):

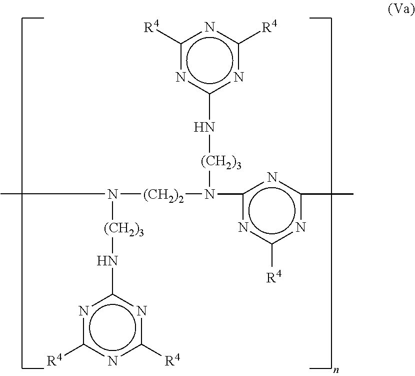

wherein each R⁴ has a structure of:

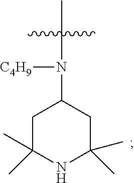

and

n is an integer selected from 1, 2, 3, 4, 5, 6, 7, 8, 9, or 10.

In some embodiments, an acrylic composition of the present invention comprises a hindered amine light stabilizer having a structure of Formula (VI). In some embodiments, in the compound of Formula (VI), each X is independently a C2-C10 alkyl, C4-C8 alkyl, C2-C10 alkenyl, or C4-C8 alkenyl; each R¹ is independently hydrogen, C1-C4 alkyl, C2-C4 alkenyl, —O(C2-C4 alkyl), or —O(C2-C4 alkenyl); each R² is independently a C1-C4 alkyl or C2-C4 alkenyl; R³ is hydrogen, C1-C10 alkyl, or C2-C10 alkenyl; and/or n is 1 to 50, 1 to 10, or 1 to 5. In some embodiments, in the compound of Formula (VI), each X is independently a C4 alkyl, C5 alkyl, C6 alkyl, or C7 alkyl; each R¹ is independently hydrogen or a C1-C4 alkyl; each R² is independently a C1-C4 alkyl; R³ is C1-C10 alkyl; and/or n is 1 to 10 or 1 to 5. In some embodiments, in the compound of Formula (VI), each X is a C6 alkyl; each R¹ is hydrogen; each R² is a methyl group; R³ is C8 alkyl; and/or n is 1 to 10.

In some embodiments, an acrylic composition of the present invention comprises a hindered amine light stabilizer having a structure of Formula (VIa):

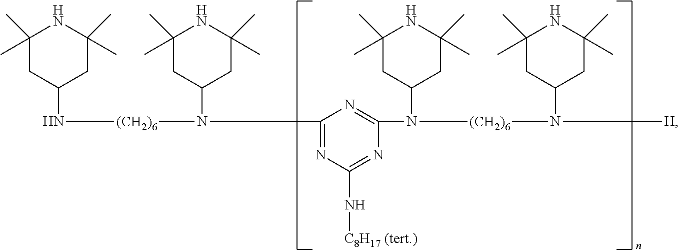

wherein n is an integer selected from 1, 2, 3, 4, 5, 6, 7, 8, 9, or 10.

In some embodiments, an acrylic composition of the present invention comprises a hindered amine light stabilizer having a structure of Formula (VII). In some embodiments, in the compound of Formula (VII), each X is independently a C2-C10 alkyl, C4-C8 alkyl, C2-C10 alkenyl, or C4-C8 alkenyl; each R¹ is independently hydrogen, C1-C4 alkyl, C2-C4 alkenyl, —O(C1-C4 alkyl), or —O(C2-C4 alkenyl); each R² is independently a C1-C4 alkyl or C2-C4 alkenyl; each R³ is independently hydrogen, C1-C10 alkyl, or C2-C10 alkenyl; and/or n is 1 to 50, 1 to 10, or 1 to 5. In some embodiments, in the compound of Formula (VII), each X is independently a C4 alkyl, C5 alkyl, C6 alkyl, or C7 alkyl; each R¹ is independently hydrogen or a C1-C4 alkyl; each R² is independently a C1-C4 alkyl; each R³ is independently a C1-C10 alkyl; and/or n is 1 to 10 or 1 to 5. In some embodiments, in the compound of Formula (VII), each X is a C6 alkyl; each R¹ is hydrogen; each R² is a methyl group; each R³ is a C4 alkyl; and/or n is 1 to 10.

In some embodiments, an acrylic composition of the present invention comprises a hindered amine light stabilizer having a structure of Formula (VIIa):

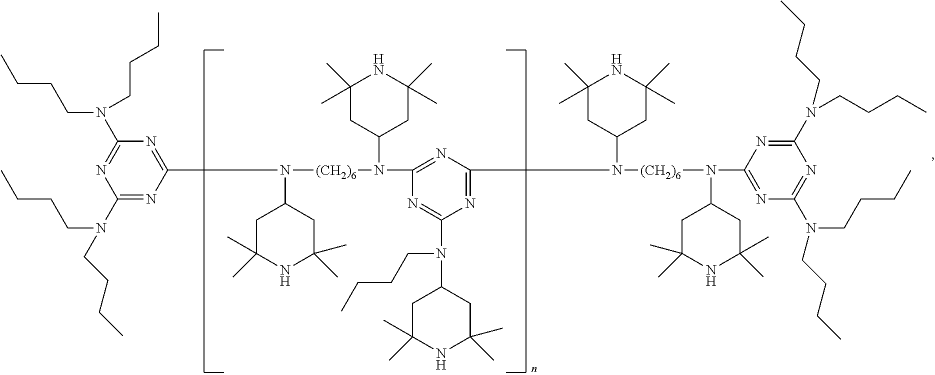

wherein n is an integer selected from 1, 2, 3, 4, 5, 6, 7, 8, 9, or 10.

In some embodiments, an acrylic composition of the present invention comprises a hindered amine light stabilizer having a structure of Formula (VIII). In some embodiments, in the compound of Formula (VIII), each R¹ is independently hydrogen, C1-C4 alkyl, C2-C4 alkenyl, —O(C1-C4 alkyl), or —O(C2-C4 alkenyl); each R² is independently a C1-C4 alkyl or C2-C4 alkenyl; and each R³ is independently hydrogen, C1-C10 alkyl, or C2-C10 alkenyl. In some embodiments, in the compound of Formula (VIII), each R¹ is independently a hydrogen or C1-C4 alkyl; each R² is independently a C1-C4 alkyl; and each R³ is independently a C1-C10 alkyl. In some embodiments, in the compound of Formula (VIII), each R¹ is a hydrogen; each R² is a methyl group; and each R³ is a C4 alkyl.

In some embodiments, an acrylic composition of the present invention comprises a hindered amine light stabilizer having a structure of Formula (VIIIa):

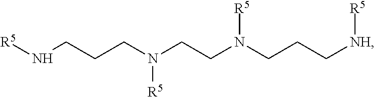

wherein each R⁵ has a structure of:

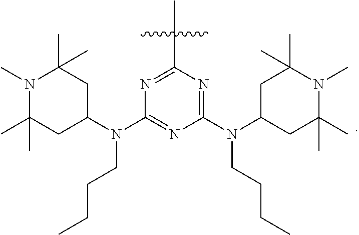

A hindered amine light stabilizer may be distributed and/or incorporated throughout an acrylic composition of the present invention. In some embodiments, the hindered amine light stabilizer is distributed and/or incorporated substantially uniformly throughout the acrylic composition (i.e., a concentration in a first portion (e.g., an outer portion) and a concentration in a second portion (e.g., an inner portion or core) are within ±20% of each other). In some embodiments, when the acrylic composition is in the form of a fiber, the hindered amine light stabilizer is distributed and/or incorporated substantially uniformly throughout the fiber and/or may be found in the center of the fiber to the outer surface of the fiber. In some embodiments, when the acrylic composition is in the form of a fiber, a first hindered amine light stabilizer may be present at, proximate to, and/or concentrated at or near a surface of the fiber and a second hindered amine light stabilizer may be distributed substantially uniformly throughout the fiber. In some embodiments, the hindered amine light stabilizer is within the acrylic fiber and/or within the polymer matrix of the acrylic fiber. In some embodiments, the hindered amine light stabilizer is distributed throughout the polymer matrix of the poly(acrylonitrile-co-methyl acrylate).

A hindered amine light stabilizer may or may not be chemically bound to a poly(acrylonitrile-co-methyl acrylate) present in the acrylic composition. In some embodiments, the hindered amine light stabilizer may be ionically and/or covalently bound to a portion of the poly(acrylonitrile-co-methyl acrylate). In some embodiments, the hindered amine light stabilizer may be associated with a portion of the poly(acrylonitrile-co-methyl acrylate) through hydrogen bonding, a Van deer Waals force, and/or a dipole interaction. In some embodiments, a hindered amine light stabilizer may be entrapped and/or encapsulated (partially or entirely) by one or more portions and/or chains of a poly(acrylonitrile-co-methyl acrylate) in an acrylic composition of the present invention. In some embodiments, a hindered amine light stabilizer may not be chemically reacted and/or bound to the poly(acrylonitrile-co-methyl acrylate), but may physically be partially or entirely entrapped and/or encapsulated by the poly(acrylonitrile-co-methyl acrylate).

An acrylic composition of the present invention may be in any suitable form, such as, e.g., in the form of a fiber, thread, yarn, and/or fabric. In some embodiments, the acrylic composition is an outdoor fabric and/or is a fabric that is suitable for outdoor applications (e.g., shade structures, awnings, marine covers, sails, outdoor furniture, etc.). In some embodiments, the acrylic composition is a fabric such as, e.g., an automotive fabric, which may be an interior and/or exterior automotive fabric. In some embodiments, an acrylic composition of the present invention is a fabric comprising an acrylic fiber, thread, and/or yarn. Also provided herein is an article, such as, but not limited to, a shade structure, awning, marine cover, outdoor furniture item, car, boat, chair, sail, and/or couch, comprising an acrylic composition of the present invention (e.g., a fiber, yarn, thread, and/or fabric).

In some embodiments, one or more (e.g., 1, 2, 3, 4, 5, 6, or more) pigment(s) may be present in the acrylic composition. In some embodiments, an acrylic composition comprises at least 2, 3, 4, or more pigments. A pigment may provide the acrylic composition with a color that is a light to medium shade or a dark shade. In some embodiments, the acrylic composition is solution-dyed. In some embodiments, the acrylic composition is unpigmented (also referred to herein as ecru or natural).

One or more (e.g., 1, 2, 3, 4, 5, or more) additional component(s) or additive(s) may be present in an acrylic composition of the present invention including, but not limited to, a heat stabilizer, catalyst, solvent, and/or impurity (e.g., residual catalyst, residual solvent, etc.). In some embodiments, a heat stabilizer (e.g., an antioxidant) may be present in an acrylic composition of the present invention in an amount known to those of skill in the art. In some embodiments, an acrylic composition of the present invention is devoid of a heat stabilizer (e.g., an antioxidant). In some embodiments, an acrylic composition of the present invention is devoid of a benzophenone, hydroxyphenylbenzotriazole, and/or UV absorber.

The inventors of the present invention discovered that a hindered amine light stabilizer can be included in an acrylic composition comprising a poly(acrylonitrile-co-methyl acrylate) and may provide improved properties. In some embodiments, improvements to the acrylic composition are provided (e.g., improvements in weatherability, UV-resistance, color stability, etc.) while maintaining or increasing fiber strength properties (e.g., tensile strength, flexibility, etc.).

An acrylic composition (e.g., fabric) of the present invention may have a UV-resistance that is increased by at least about 10% (e.g., at least about 20%, 30%, or more) compared to a comparative composition. In some embodiments, increased UV-resistance may be determined with an unpigmented acrylic composition of the present invention and an unpigmented comparative composition. For example, an unpigmented acrylic composition of the present invention and an unpigmented comparative composition and/or one or more properties thereof may be compared.

“Comparative composition” as used herein collectively refers to a current commercial acrylic composition and/or a control composition, each of which may be in the same form as the acrylic composition of the present invention that it is being compared to. An example current commercial acrylic composition of the same form may be, but is not limited to, a current commercial acrylic fabric (e.g., a current commercial acrylic outdoor fabric) when the acrylic composition of the present invention is a fabric. An example control composition of the same form is when the acrylic composition of the present invention is in the form of, e.g., a fabric, the control composition is a fabric prepared in the same manner with the same materials except without a hindered amine light stabilizer. Similarly, when the acrylic composition of the present invention is a fiber or yarn, the control composition is a fiber or yarn, respectively, prepared in the same manner with the same materials except without a hindered amine light stabilizer. In some embodiments, a comparative composition comprises a poly(acrylonitrile-co-methyl acrylate) having acrylonitrile units in an amount of about 90% to about 94% by weight of the polymer, methyl acrylate units in an amount of about 6% to about 9% by weight of the polymer, and optionally acid comonomer units in an amount of about 0% to about 1% by weight of the polymer. In some embodiments, a comparative composition is devoid of a hindered amine light stabilizer and devoid of a pigment.

In some embodiments, an acrylic composition (e.g., fabric) of the present invention has a color stability that is increased by at least about 10% (e.g., at least about 20%, 30%, or more) compared to a current commercial acrylic composition of the same form (e.g., a current commercial acrylic fabric) and/or a control composition of the same form (e.g., a fabric without a hindered amine light stabilizer). In some embodiments, improvements in color stability may be determined upon visual comparison with the human eye. In some embodiments, increased color stability may be determined with an unpigmented acrylic composition of the present invention and/or an unpigmented comparative composition, e.g., by comparing the compositions and/or one or more properties thereof.

An acrylic composition (e.g., fabric) of the present invention may have reduced or no discoloration (e.g., yellowing or browning) compared to a current commercial acrylic composition of the same form (e.g., a current commercial acrylic fabric) and/or a control composition of the same form (e.g., a fabric without a hindered amine light stabilizer). In some embodiments, the acrylic composition has a reduction in discoloration of at least about 5%, 10%, 15%, 20%, 25%, 30%, 35%, 40%, 45%, 50%, or more compared to a comparative composition. In some embodiments, discoloration may be determined with an unpigmented acrylic composition of the present invention and/or an unpigmented comparative composition. “Discoloration” as used herein, refers to any change in color compared to the initial (i.e., original) color of the acrylic composition upon formation of the acrylic composition (i.e., at time point 0). In some embodiments, discoloration may appear as a change in the color (e.g., a change to a different shade and/or a color shift) of the acrylic composition, fading of the color of the acrylic composition, staining of the acrylic composition, and/or yellowing or browning of the acrylic composition (i.e., the appearance of yellow or brown in the acrylic composition).

In some embodiments, an acrylic composition (e.g., fabric) of the present invention may have reduced or no discoloration (e.g., yellowing or browning) after a period of time and/or after exposure to certain conditions compared to the original color of the acrylic composition. When compared to the original color of the acrylic composition, an acrylic composition of the present invention may have no discoloration or a reduction in discoloration of at least about 5%, 10%, 15%, 20%, 25%, 30%, 35%, 40%, 45%, 50%, or more after a period of time and/or after exposure to certain conditions. The amount of discoloration may be determined and/or measured at any point in time, such as, e.g., at about 1, 2, 3, 4, 5, 6, 7, 8, 9, 10, 11, 12, 13, 14, 15, 16, 17, 18, 19, 20, 21, 22, 23, 24 month(s) or year(s) or more after initial formation of the acrylic composition. In some embodiments, the amount of discoloration may be determined and/or measured after exposure to certain conditions, such as, but not limited to, real world outdoor conditions (e.g., in California, Arizona and/or Texas), sun exposure, heat exposure, and/or conditions in accordance with AATCC 169 Option 3 (AATCC TM169-2009, “Weather Resistance of Textiles: Xenon Lamp Exposure” Developed in 1987 by AATCC Committee RA64 (editorially revised and reaffirmed 2009)). In some embodiments, discoloration of an acrylic composition of the present invention is determined and/or measured after the acrylic composition is exposed to 880, 1320, or 2200 kJ in accordance with AATCC 169 Option 3. In some embodiments, the AATCC 169 Option 3 test method is performed using a borosilicate/borosilicate filter with 0.35 W/m² irradiance at 340 nm, 77° C.±3° C. black panel temperature, 27±3% relative humidity (RH) with continuous light exposure. In some embodiments, an acrylic composition (e.g., fabric) of the present invention that is devoid of a benzophenone, hydroxyphenylbenzotriazole, triazine, and/or UV absorber may have reduced or no discoloration (e.g., yellowing or browning) after a period of time and/or after exposure to certain conditions compared to the original color of the acrylic composition.

In some embodiments, an acrylic composition of the present (e.g., fabric) has a weatherability that is increased by at least 5% (e.g., about 10%, 15%, 20%, 25%, 30%, or more) compared to a current commercial acrylic composition of the same form (e.g., a current commercial acrylic fabric) and/or a control composition of the same form (e.g., a fabric without a hindered amine light stabilizer). Weatherability may be measured using methods known to those of skill in the art, such as, but not limited to, artificial simulations of weathering using a xenon arc such as, e.g., AATCC 169 Option3 (AATCC TM169-2009, “Weather Resistance of Textiles: Xenon Lamp Exposure” Developed in 1987 by AATCC Committee RA64 (editorially revised and reaffirmed 2009); AATCC Test Method 16.3-2014 “Colorfastness to Light: Xenon-Arc”; SAE J2527 “Performance Based Standard for Accelerated Exposure of Automotive Exterior Materials Using a Controlled Irradiance Xenon-Arc Apparatus” J2527_200402, Issued: Feb. 11, 2004; ISO 105-B04:1994 “Textiles—Tests for colour fastness—Part B04: Colour fastness to artificial weathering: Xenon arc fading lamp test”; ISO 105-B02:2014(en) “Textiles—Tests for colour fastness—Part B02: Colour fastness to artificial light: Xenon arc fading lamp test”; and ASTM G154-16, “Standard Practice for Operating Fluorescent Ultraviolet (UV) Lamp Apparatus for Exposure of Nonmetallic Materials,” ASTM International, West Conshohocken, Pa., 2016. In some embodiments, weatherability, color stability and/or one or more physical properties of an acrylic composition of the present invention may be tested in regard to resistance to acid, rain, salt, pollutant(s), and/or chemical(s) using methods known to those of skill in the art.

The weatherability may be measured and/or determined upon initial formation of the composition and/or at about 1, 2, 3, 4, 5, 6, 7, 8, 9, 10, 11, 12, 13, 14, 15, 16, 17, 18, 19, 20, 21, 22, 23, 24 month(s) or year(s) or more after initial formation of the composition and/or after exposure to certain conditions, such as, but not limited to, real world outdoor conditions (e.g., in California, Arizona and/or Texas), sun exposure, heat exposure, and/or conditions in accordance with AATCC 169 Option 3. In some embodiments, the acrylic composition has a weatherability that is increased by at least 5%, 10%, 15%, or 20% at about 3, 6, 9, or 12 months or 5 or 10 years (e.g., 3, 6, 9, or 12 months or 5 or 10 years of outdoor exposure) and/or after exposure to 880, 1320, or 2200 kJ in accordance with AATCC 169 Option 3 compared to a comparative composition. In some embodiments, improvements in weatherability of an acrylic composition of the present invention compared to a comparative composition may be determined by comparing the tensile strength, break strength, and/or flexibility of the compositions. In some embodiments, weatherability may be determined with an unpigmented acrylic composition of the present invention and/or an unpigmented comparative composition, e.g., by comparing the compositions and/or one or more properties thereof.

UV-resistance, color stability, weatherability, and/or discoloration may be measured and/or determined using methods known to those of skill in the art. In some embodiments, UV-resistance, color stability, weatherability, and/or discoloration may be measured and/or determined by measuring and/or determining the difference and/or distance between a first color (e.g., a first color value) and a second color (e.g., a second color value). In some embodiments, the difference and/or distance between a first color and a second color may be measured and/or determined by measuring and/or determining the CIE Delta E and/or Gray Scale value. The CIE Delta E values are CIELAB units of color change as determined by AATCC 169 Option 3. In some embodiments, the CIE Delta E and/or Gray Scale value may be determined in accordance with AATCC Evaluation Procedure 6, “Instrumental Color Measurement” and/or AATCC Evaluation Procedure 1, “Gray Scale for Color Change”. The first color and second color may be from the same composition, but at different points in time and/or after exposure to certain conditions (e.g., same sample tested at different times). In some embodiments, the first color and second color are the same. In some embodiments, the first color may be the initial color of the acrylic composition and the second color may be the color of the acrylic composition after a period of time and/or exposure to certain conditions. In some embodiments, the first color may be the color of the acrylic composition after a period of time and/or after exposure to certain conditions and the second color may be the color of a comparative composition of the same form after the same period of time and/or after exposure to the same conditions. In some embodiments, a CIE Delta E and/or Gray Scale value may be determined after exposure for at least about 7 days to a temperature of about 85° C. to about 100° C. (e.g., about 85° C.) in forced air oven and/or may be determined in accordance with LP-463LB-13-01, 5-4-2006, “Heat Aging of Trim Materials”. In some embodiments, color change and/or a CIE Delta E and/or Gray Scale value may be measured devoid of a pigment (e.g., the acrylic composition is unpigmented), which may allow for any change in color or value to more easily be observed.

Color and/or change in color of an acrylic composition may be accessed by CIELAB color space as specified by the International Commission on Illumination in 1994, such as by DL, which is a difference in lightness/darkness value wherein a positive value represents a shift to a lighter color and a negative value represents a shift to a darker color; Da, which is a difference on the red/greed axis wherein a positive value represents a shift to a redder color and a negative value represents a shift to a greener color; Db, which is a difference on the yellow/blue axis wherein a positive value represent a shift to a yellower color and a negative value represents a shift to a bluer color; and/or DE, which is a total color difference value. In some embodiments, an acrylic composition (e.g., an acrylic fiber and/or fabric) of the present invention, after exposure to about 50 kJ to about 200 kJ of light and optionally when measured devoid of a pigment, has a negative DL value, a positive Da value, and/or a negative Db value based on color of the acrylic composition prior to exposure to about 50 kJ to about 200 kJ of light. Thus, after exposure to about 50 kJ to about 200 kJ of light, the acrylic composition may shift to a slightly darker color, shift more red, and/or shift less yellow/more blue compared to the color prior to exposure to about 50 kJ to about 200 kJ of light. After exposure to about 50 kJ to about 200 kJ of light (e.g., 50, 100, 150, or 200 kJ), the acrylic composition (e.g., including a hindered amine light stabilizer have a pKa of about 9 or more such as 9 or 9.5 to 10, 10.5 or 11) may have a DL value of about 0 or −0.1 to about −0.2, −0.3, −0.4, −0.5, −0.6, −0.7, −0.8, −0.9, or −1; a Da value of about 0.5, 0.6, 0.7, 0.8, 0.9, or 1 to about 1.1, 1.2, 1.3, 1.4, 1.5, 1.6, 1.7, 1.8, 1.9, or 2; a Db value of about −2.5 or −3 to about −3.1, −3.2, −3.3, −3.4, −3.5, −3.6, −3.7, −3.8, −3.9, −4, −4.1, −4.2, −4.3, −4.4, or −4.5; and/or a DE value of about 2, 2.5, or 3 to about 3.1, 3.2, 3.3, 3.4, 3.5, 3.6, 3.7, 3.8, 3.9, 4, 4.1, 4.2, 4.3, 4.4, or 4.5. In some embodiments, after exposure to about 50 kJ to about 200 kJ of light (e.g., 50, 100, 150, or 200 kJ), the acrylic composition may have a DL value of about 0, −0.1, −0.2, −0.3, −0.4, −0.5, −0.6, −0.7, −0.8, −0.9, or −1; a Da value of about 0.5, 0.6, 0.7, 0.8, 0.9, 1, 1.1, 1.2, 1.3, 1.4, 1.5, 1.6, 1.7, 1.8, 1.9, or 2; a Db value of about −2.5, −3, −3.1, −3.2, −3.3, −3.4, −3.5, −3.6, −3.7, −3.8, −3.9, −4, −4.1, −4.2, −4.3, −4.4, or −4.5; and/or a DE value of about 2, 2.5, 3, 3.1, 3.2, 3.3, 3.4, 3.5, 3.6, 3.7, 3.8, 3.9, 4, 4.1, 4.2, 4.3, 4.4, or 4.5. In some embodiments, an acrylic composition (e.g., an acrylic fiber and/or fabric) of the present invention, after exposure to about 800 kJ to about 2500 kJ of light and optionally when measured devoid of a pigment, has a positive DL value, a positive Da value, and/or a negative Db value based on color of the acrylic composition prior to exposure to about 800 kJ to about 2500 kJ of light. Thus, after exposure to about 800 kJ to about 2500 of light, the acrylic composition may shift to a slightly lighter color, shift more red, and/or shift less yellow/more blue compared to the color prior to exposure to about 800 kJ to about 2500 kJ of light. After exposure to about 800 kJ to about 2500 kJ of light (e.g., 880, 1320, or 2200 kJ), the acrylic composition (e.g., including a hindered amine light stabilizer have a pKa of about 9 or more such as 9 or 9.5 to 10, 10.5 or 11) may have a DL value of about 0, 0.05, 0.1, or 0.2 to about 0.3, 0.4, 0.5, 0.6, 0.7, 0.8, 0.9, or 1; a Da value of about 0, 0.05, or 0.1 to about 0.15, 0.2, 0.25, or 0.3; a Db value of about 0, −0.05, or −0.1 to about −0.3, −0.4, −0.5, −0.6, −0.7, −0.8, −0.9, or −1; and/or a DE value of about 0.1, 0.2, or 0.3 to about 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, or 2.5. In some embodiments, after exposure to about 800 kJ to about 2500 kJ of light (e.g., 880, 1320, or 2200 kJ), the acrylic composition may have a DL value of about 0, 0.05, 0.1, 0.2, 0.3, 0.4, 0.5, 0.6, 0.7, 0.8, 0.9, or 1; a Da value of about 0, 0.05, 0.1, 0.15, 0.2, 0.25, or 0.3; a Db value of about 0, −0.05, −0.1, −0.3, −0.4, −0.5, −0.6, −0.7, −0.8, −0.9, or −1; and/or a DE value of about 0.1, 0.2, or 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, or 2.5. In some embodiments, the acrylic composition (e.g., including a hindered amine light stabilizer have a pKa of about 9 or more such as 9 or 9.5 to 10, 10.5 or 11) has a less color change (e.g., a DE of less than 3, 2.5, 2, 1.5 or 1) after exposure to about 800 kJ to about 2500 kJ of light than compared to the color change after exposure to about 50 kJ to about 200 kJ of light. In some embodiments, the acrylic composition after exposure to about 800 kJ to about 2500 kJ of light has a DE of less than 3, 2.5, 2, 1.5, or 1 and/or a Gray scale value of about 4 to about 5 (e.g., 4, 4-5, or 5). In some embodiments, an acrylic composition of the present invention has no or minimal visually perceptive change in color after exposure to about 50 kJ to about 2500 kJ of light (e.g., after exposure to about 50, 100, 150 200, 880, 1320, or 2200 kJ of light).

In some embodiments, an acrylic composition of the present invention, optionally when measured devoid of a pigment, exhibits no or minimal visually perceptive color change after exposure to about 50 kJ to about 2500 kJ of light (e.g., about 50, 60, 70, 80, 90, 100, 110, 120, 130, 140, 150, 160, 170, 180, 190, 200, 880, 1320, or 2200 kJ of light) and/or has a Gray scale value of in a range of 3 and 5 after exposure to about 50 kJ to about 2500 kJ of light. In some embodiments, minimal visually perceptive color change may correspond with a Gray scale rating of 4 and/or a DE of 1 to 2. In some embodiments, an acrylic composition of the present invention, after exposure to about 50 kJ to about 2500 kJ of light, has no or minimal visually perceptive change in color compared to the acrylic composition after exposure to a different amount of light of about 50 kJ to about 2500 kJ. For example, an acrylic composition after exposure to about 50 kJ of light may have no or minimal visually perceptive change in color compared to the acrylic composition after exposure to 200 or 880 kJ of light. In some embodiments, the acrylic composition, optionally when measured devoid of a pigment, has a Gray scale value of about 3, 3-4, 4, 4-5, or 5 after exposure to about 50 kJ to about 2500 kJ of light (e.g., after exposure to about 50, 100, 150 200, 880, 1320, or 2200 kJ of light). In some embodiments, an acrylic composition of the present invention, after exposure to about 50 kJ of light and optionally when measured devoid of a pigment, exhibits no or minimal visually perceptive color change and/or has a Gray scale value of 3, 3-4, 4, 4-5, or 5. In some embodiments, an acrylic composition of the present invention, after exposure to about 50 kJ of light and optionally when measured devoid of a pigment and after exposure to about 2500 kJ of light, exhibits no or minimal visually perceptive color change and/or has a Gray scale value of 3, 3-4, 4, 4-5, or 5.

An acrylic composition (e.g., an acrylic fiber and/or fabric) of the present invention may provide improved polymer stabilization, less degradation and/or less color shift to yellow than an acrylic composition not in accordance with the present invention (e.g., an acrylic composition including poly(acrylonitrile-co-vinyl acetate) and devoid of poly(acrylonitrile-co-methyl acrylate)). For example, after exposure to about 800 kJ to about 2500 kJ (e.g., about 880, 1320, or 2200 kJ) of light an acrylic composition of the present invention that is optionally devoid of a pigment may have a DE of less than 3, 2.5, 2, 1.5, or 1 and/or Db of about 0 to about −1, whereas, after exposure to the same amount of light, an acrylic composition comprising poly(acrylonitrile-co-vinyl acetate) and a hindered amine light stabilizer (optionally the same hindered amine light stabilizer) that is optionally devoid of a pigment and devoid of poly(acrylonitrile-co-methyl acrylate) may have a DE of greater than 1 (optionally greater than 1.5, 2, 3, 4, or 5) and/or a Db of about −2 to about −7. Without wishing to be bound by any particular theory, weak conjugate bonds may form in an acrylic composition of the present invention, which may create a chromophore in the acrylic polymer (see, e.g., Scheme 1). This may be due to the basicity of the hindered amine light stabilizer in the acrylic composition. An acrylic composition of the present invention including poly(acrylonitrile-co-methyl acrylate) may not shift yellow or may slightly shift yellow, whereas an acrylic composition including poly(acrylonitrile-co-vinyl acetate) may have a greater and/or more pronounced yellow shift. Upon exposure of an acrylic composition of the present invention to UV light, weak conjugate bonds may break and a shift away from a yellow appearance may occur, as such a spectrophotometer may measure a value toward a more blue color (i.e., a negative Db value). This change could occur after a few days of exposure to normal outdoor environment or to about 50 kJ as measured in accordance with ACC 169. The degree of shift seen for an acrylic composition may depend on the comonomer (e.g., methyl acrylate or vinyl acetate) and/or hindered amine light stabilizer present in the acrylic composition. After a period of longer exposure, such as 2,000 kJ, new polymer structures may be formed as breakdown of the polymer occurs and/or a shift may be observed moving back toward a yellow side; however, better polymer stabilization systems will have less degradation and therefore less shift to the yellow side (Db).

In some embodiments, an acrylic composition of the present invention may have a CIE Delta E value of about 20, 19, 18, 17, 16, 15, 14, 13, 12, 11, 10, 9, 8, 7, 6, 5, 4, 3, 2, 1, or less when measuring the color of the acrylic composition after a period of time and/or after exposure to certain conditions compared to the initial color of the acrylic composition. In some embodiments, the CIE Delta E is measured at about 1, 2, 3, 4, 5, 6, 7, 8, 9, 10, 11, 12, 13, 14, 15, 16, 17, 18, 19, 20, 21, 22, 23, 24 month(s) or year(s) or more after initial formation of the acrylic composition and/or after exposure to certain conditions, such as, but not limited to, real world outdoor conditions (e.g., in California, Arizona and/or Texas), sun exposure, heat exposure, and/or conditions in accordance with AATCC 169 Option 3. In some embodiments, an acrylic composition of the present invention (e.g., fabric) has a CIE Delta E value of less than about 3, 2, or 1 at about 3, 6, 9, or 12 months or 5 or 10 years (e.g., 3, 6, 9, or 12 months or 5 or 10 years of outdoor exposure) and/or after exposure to 880, 1320, or 2200 kJ in accordance with AATCC 169 Option 3.

In some embodiments, the CIE Delta E of an acrylic composition of the present invention (e.g., a fabric) varies (i.e., increases or decreases) by less than about ±70%, 65%, 60%, 55%, 50%, 45%, 40%, 35%, 30%, 25%, 20%, 15%, 10%, or 5% after a period of time and/or after exposure to certain conditions compared to a prior CIE Delta E value for the acrylic composition. For example, in some embodiments, the CIE Delta E value at about 3 months varies by less than about ±70% compared to the CIE Delta E value at about 6, 9, 12, 18, or 24 months and/or the CIE Delta E value after exposure to 880 kJ varies by less than about ±70% compared to the CIE Delta E value after exposure to 2200 kJ in accordance with AATCC 169 Option 3. In some embodiments, an acrylic composition of the present invention (e.g., fabric) has a CIE Delta E value that varies by less than about ±70%, 65%, 60%, 55%, 50%, 45%, 40%, 35%, 30%, 25%, 20%, 15%, 10%, or 5% at about 3, 6, 9, and/or 12 months and/or 5 and/or 10 years (e.g., 3, 6, 9, or 12 months or 5 or 10 years of outdoor exposure) and/or after exposure to 880, 1320, and/or 2200 kJ in accordance with AATCC 169 Option 3 compared to a prior CIE Delta E value.

In some embodiments, the CIE Delta E of an acrylic composition of the present invention (e.g., a fabric) varies by less than about ±70%, 65%, 60%, 55%, 50%, 45%, 40%, 35%, 30%, 25%, 20%, 15%, 10%, or 5% over a 12 month time period during which the acrylic composition is exposed to certain conditions, such as, but not limited to, real world outdoor conditions (e.g., in California, Arizona and/or Texas), sun exposure, heat exposure, and/or conditions in accordance with AATCC 169 Option 3. The variance over the 12 month time period (e.g., 12 months after initial formation of the acrylic composition) may be determined by comparing the lowest CIE Delta E value and highest CIE Delta E value measured during the 12 month period to determine the percent difference. In some embodiments, the CIE Delta E value increases by less than about ±70%, 65%, 60%, 55%, 50%, 45%, 40%, 35%, 30%, 25%, 20%, 15%, 10%, or 5% during the 12 month time period.

In some embodiments, the CIE Delta E of an acrylic composition of the present invention (e.g., a fabric) increases by less than about 70%, 65%, 60%, 55%, 50%, 45%, 40%, 35%, 30%, 25%, 20%, 15%, 10%, 5%, 1%, or 0% after a period of time and/or after exposure to certain conditions compared to a prior CIE Delta E value. For example, in some embodiments, the CIE Delta E value at 3 months increases by less than about 70% compared to the CIE Delta E value at 6, 9, 12, 18, or 24 months and/or the CIE Delta E value after exposure to 880 kJ increases by less than about 70% compared to the CIE Delta E value after exposure to 2200 kJ in accordance with AATCC 169 Option 3. In some embodiments, an acrylic composition of the present invention (e.g., fabric) has a CIE Delta E value that increases by less than about 70%, 65%, 60%, 55%, 50%, 45%, 40%, 35%, 30%, 25%, 20%, 15%, 10%, 5%, 1%, or 0% at about 3, 6, 9, and/or 12 months and/or 5 and/or 10 years (e.g., 3, 6, 9, or 12 months or 5 or 10 years of outdoor exposure) and/or after exposure to 880, 1320, and/or 2200 kJ in accordance with AATCC 169 Option 3 compared to a prior CIE Delta E value.

In some embodiments, an increase in UV-resistance, weatherability, and/or color stability and/or a reduction in discoloration is determined by comparing the CIE Delta E for an acrylic composition of the present invention and the CIE Delta E for a comparative composition (e.g., a control composition of the same form), wherein the CIE Delta E for each is measured after a period of time and/or after exposure to certain conditions compared to the initial color of each composition. An increase in UV-resistance, weatherability, and/or color stability and/or a reduction in discoloration may be demonstrated by the acrylic composition having a lower CIE Delta E value than the CIE Delta E value of the comparative composition, optionally at the same point in time and/or after exposure to the same conditions. In some embodiments, the acrylic composition may have a CIE Delta E value that is lower by at least about 5%, 10%, 15%, 20%, 25%, 30%, 35%, 40%, 45%, 50%, 55%, 60%, 65%, 70% or more compared to the CIE Delta E value of the comparative composition, optionally at the same point in time and/or after exposure to the same conditions.

In some embodiments, an acrylic composition of the present invention may have a Gray Scale value of about 2-3, 3, 3-4, 4, 4-5, or 5 when measuring the color of the acrylic composition after a period of time and/or after exposure to certain conditions compared to the initial color of the acrylic composition. In some embodiments, the Gray Scale value is measured at about 1, 2, 3, 4, 5, 6, 7, 8, 9, 10, 11, 12, 13, 14, 15, 16, 17, 18, 19, 20, 21, 22, 23, 24 month(s) or year(s) or more after initial formation of the acrylic composition and/or after exposure to certain conditions, such as, but not limited to, real world outdoor conditions (e.g., in California, Arizona and/or Texas), sun exposure, heat exposure, and/or conditions in accordance with AATCC 169 Option 3. In some embodiments, an acrylic composition of the present invention (e.g., fabric) has a Gray Scale value of about 3-4, 4, 4-5, or 5 at about 3, 6, 9, or 12 months or 5 or 10 years (e.g., 3, 6, 9, or 12 months or 5 or 10 years of outdoor exposure) and/or after exposure to 880, 1320, or 2200 kJ in accordance with AATCC 169 Option 3.

In some embodiments, the Gray Scale value of an acrylic composition of the present invention (e.g., a fabric) varies by ±0, 0.5, 1, 1.5, or 2 after a period of time and/or after exposure to certain conditions compared to the initial color of the acrylic composition. In some embodiments, an acrylic composition of the present invention (e.g., fabric) has a Gray Scale value that varies by ±0, 0.5, 1, 1.5, or 2 at about 3, 6, 9, or 12 months or 5 or 10 years (e.g., 3, 6, 9, or 12 months or 5 or 10 years of outdoor exposure) and/or after exposure to 880, 1320, or 2200 kJ in accordance with AATCC 169 Option 3.

In some embodiments, an increase in UV-resistance, weatherability, and/or color stability and/or a reduction in discoloration is determined by comparing the Gray Scale value for an acrylic composition of the present invention and the Gray Scale value for a comparative composition (e.g., a control composition of the same form), wherein the Gray Scale value for each is measured after a period of time and/or after exposure to certain conditions compared to the initial color of each composition. An increase in UV-resistance, weatherability, and/or color stability and/or a reduction in discoloration may be demonstrated by the acrylic composition having a higher Gray Scale value than the Gray Scale value of the comparative composition, optionally at the same point in time and/or after exposure to the same conditions. In some embodiments, the acrylic composition may have a Gray Scale value that is higher by at least 0.5, 1, 1.5, 2, 2.5, 3, 3.5, or 4 compared to the Gray Scale value of the comparative composition, optionally at the same point in time and/or after exposure to the same conditions.

As described above, it was surprisingly discovered by the inventors of the present invention that UV-resistance, color stability, weatherability, and/or discoloration of an acrylic composition of the present invention may be improved by including a hindered amine light stabilizer compared to a comparative composition. In some embodiments, an acrylic composition of the present invention may provide one or more improved physical properties compared to a comparative composition. Inclusion of an additive may negatively affect one or more physical properties of the fiber (e.g., tensile strength, break strength, flexibility, etc.). In some embodiments, one or more physical properties such as, e.g., strength and/or elongation retention, may be greater after exposure to certain conditions (e.g., after exposure to 100, 250, 500, 880, 1320, or 2200 kJ in accordance with AATCC 169 Option 3) when a hindered amine light stabilizer is included in an acrylic composition of the present invention compared a control composition without the hindered amine light stabilizer. In some embodiments of the present invention, no or minimal reduction in fine physical structures and/or properties is observed. In some embodiments, an acrylic composition of the present invention (e.g., fabric) has a strength retention that is increased by at least 5% or 10% (e.g., about 5%, 10%, 15%, 20%, 25%, 30%, or more) compared to a current commercial acrylic composition of the same form (e.g., a current commercial acrylic fabric) and/or a control composition of the same form (e.g., a fabric without a hindered amine light stabilizer). Strength retention may be measured in accordance with AATCC 169 Option 3.

In some embodiments, an acrylic composition of the present invention may have a tear strength loss in the warp and/or fill direction of less than about 50% (e.g., less than about 45%, 40%, 35%, 30%, 25%, 20%, 15%, 10%, or 5%) after exposure to about 800 kJ to about 2500 kJ (e.g., 880, 1320, or 2200 kJ) in accordance with AATCC 169 Option 3. In some embodiments, an acrylic composition of the present invention may have an increased tear strength in the warp and/or fill direction of about 1%, 2%, 3%, 4%, 5%, 6%, or more after exposure to about 800 kJ to about 2500 kJ (e.g., 880, 1320, or 2200 kJ) in accordance with AATCC 169 Option 3. Tear strength loss or tear strength increase may be determined by measuring the tear strength before and after exposure to about 800 kJ to about 2500 kJ (e.g., 880, 1320, or 2200 kJ) in accordance with AATCC 169 Option 3. In some embodiments, after exposure to about 800 kJ to about 2500 kJ (e.g., 880, 1320, or 2200 kJ) in accordance with AATCC 169 Option 3, an acrylic composition of the present invention may have an improved tear strength in the warp and/or fill direction compared to tear strength in the warp and/or fill direction for an acrylic composition not in accordance with the present invention (e.g., an acrylic composition that is the same as the composition being compared to but devoid of a hindered amine light stabilizer). For example, after exposure to about 800 kJ to about 2500 kJ (e.g., 880, 1320, or 2200 kJ) in accordance with AATCC 169 Option 3, an acrylic composition of the present invention may have less tear strength loss and/or an increased tear strength in warp and/or fill direction compared to tear strength loss and/or tear strength for an acrylic composition not in accordance with the present invention (e.g., an acrylic composition that is the same as the composition being compared to but devoid of a hindered amine light stabilizer). In some embodiments, after exposure to about 800 kJ to about 2500 kJ (e.g., 880, 1320, or 2200 kJ) in accordance with AATCC 169 Option 3, an acrylic composition not in accordance with the present invention has a tear strength loss in the warp and/or fill direction that is greater by about 5, 10, 15, 20, 25, 30, 35, 40, 45, 50 or more compared to the tear strength loss in the warp and/or fill direction for an acrylic composition of the present invention. In some embodiments, after exposure to about 800 kJ to about 2500 kJ (e.g., 880, 1320, or 2200 kJ) in accordance with AATCC 169 Option 3, an acrylic composition of the present invention has a tear strength in the warp and/or fill direction that is greater by about 1, 2, 3, 4, 5, 6, 7, 8, 9, 10, 11, 12, 13, 14, 15, or more pounds compared to the tear strength in the warp and/or fill direction for an acrylic composition not in accordance with the present invention.

In some embodiments, an acrylic composition of the present invention (e.g., fabric) has a tensile strength that is increased by at least 5% (e.g., about 10%, 15%, 20%, 25%, 30%, or more) compared to a current commercial acrylic composition of the same form (e.g., a current commercial acrylic fabric) and/or a control composition of the same form (e.g., a fabric without a hindered amine light stabilizer). Tensile strength may be measured in accordance with ASTM D2256/D2256M-10(2015), Standard Test Method for Tensile Properties of Yarns by the Single-Strand Method, ASTM International, West Conshohocken, Pa., 2015 and/or ASTM D5035-11(2015), Standard Test Method for Breaking Force and Elongation of Textile Fabrics (Strip Method), ASTM International, West Conshohocken, Pa., 2015. Tensile strength of a fabric may be measured in the machine direction and/or the cross machine direction of the fabric structure. The tensile strength may be measured and/or determined upon initial formation of the composition and/or at about 1, 2, 3, 4, 5, 6, 7, 8, 9, 10, 11, 12, 13, 14, 15, 16, 17, 18, 19, 20, 21, 22, 23, 24 month(s) or year(s) or more after initial formation of the composition and/or after exposure to certain conditions, such as, but not limited to, real world outdoor conditions (e.g., in California, Arizona and/or Texas), sun exposure, heat exposure, and/or conditions in accordance with AATCC 169 Option 3. In some embodiments, the acrylic composition has a tensile strength that is increased by at least 5%, 10%, 15%, or 20% at about 3, 6, 9, or 12 months or 5 or 10 years (e.g., 3, 6, 9, or 12 months or 5 or 10 years of outdoor exposure) and/or after exposure to 880, 1320, or 2200 kJ in accordance with AATCC 169 Option 3 compared to a comparative composition (e.g., a control composition of the same form). In some embodiments, after exposure to 880, 1320, or 2200 kJ in accordance with AATCC 169 Option 3, the acrylic composition (e.g., fiber or yarn (e.g., a 10″ yarn sample)) may be wrapped in one layer thickness around a 5.5″ polystyrene plaque and tested on tensile tester (e.g., an Intron tensile tester) for tensile strength, and the results may be done in replicate and averaged. In some embodiments, tensile strength may be determined with an unpigmented acrylic composition of the present invention and/or an unpigmented comparative composition, e.g., by comparing the compositions and/or one or more properties thereof.

In some embodiments, the tensile strength an acrylic composition of the present invention (e.g., a fabric) varies by about 0% or by less than about ±50%, 45%, 40%, 35%, 30%, 25%, 20%, 15%, 10%, 5%, or 1% after a period of time and/or after exposure to certain conditions compared to the initial tensile strength of the acrylic composition. In some embodiments, an acrylic composition of the present invention (e.g., fabric) has a tensile strength that varies by about 0% or by less than about ±50%, 45%, 40%, 35%, 30%, 25%, 20%, 15%, 10%, 5%, or 1% at about 3, 6, 9, or 12 months or 5 or 10 years (e.g., 3, 6, 9, or 12 months or 5 or 10 years of outdoor exposure) and/or after exposure to 880, 1320, or 2200 kJ in accordance with AATCC 169 Option 3.

In some embodiments, an acrylic composition may be in the form of a fiber and/or yarn, such as, e.g., a yarn having a 18/2 Ring Spun Cotton Count, and may have a tensile strength in a range of about 2 lbs/breaking force to about 4 lbs/breaking force, such as, e.g., 2.3 to 3.8 lbs/breaking force, optionally on average. In some embodiments, a fiber and/or yarn may have a tensile strength of about 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, or 4 lbs/breaking force, optionally on average. In some embodiments, the tensile strength of a fiber and/or yarn may be measured using a rate of speed of about 12 inches per minute, optionally using an Instron® system.

In some embodiments, an acrylic composition of the present invention (e.g., fabric) has a break strength and/or flexibility that is increased by at least 5% (e.g., about 10%, 15%, 20%, 25%, 30%, or more) compared to a current commercial acrylic composition of the same form (e.g., a current commercial acrylic fabric) and/or a control composition of the same form (e.g., a fabric without a hindered amine light stabilizer). Break strength and/or flexibility may be measured in accordance with ASTM D5034-09(2013), Standard Test Method for Breaking Strength and Elongation of Textile Fabrics (Grab Test), ASTM International, West Conshohocken, Pa., 2013. Break strength and/or flexibility of a fabric may be measured in the machine direction and/or the cross machine direction of the fabric structure. The break strength and/or flexibility may be measured and/or determined upon initial formation of the composition and/or at about 1, 2, 3, 4, 5, 6, 7, 8, 9, 10, 11, 12, 13, 14, 15, 16, 17, 18, 19, 20, 21, 22, 23, 24 month(s) or years(s) or more after initial formation of the composition and/or after exposure to certain conditions, such as, but not limited to, real world outdoor conditions (e.g., in California, Arizona and/or Texas), sun exposure, heat exposure, and/or conditions in accordance with AATCC 169 Option 3. In some embodiments, the acrylic composition has a break strength and/or flexibility that is increased by at least 5%, 10%, 15%, or 20% at about 3, 6, 9, or 12 months or 5 or 10 years (e.g., 3, 6, 9, or 12 months or 5 or 10 years of outdoor exposure) and/or after exposure to 880, 1320, or 2200 kJ in accordance with AATCC 169 Option 3 compared to a comparative composition (e.g., a control composition of the same form). In some embodiments, after exposure to 880, 1320, or 2200 kJ in accordance with AATCC 169 Option 3, the acrylic composition (e.g., fiber or yarn (e.g., a 10″ yarn sample)) may be wrapped in one layer thickness around a 5.5″ polystyrene plaque and tested on tensile tester (e.g., an Instron tensile tester) for break strength and/or flexibility, and the results may be done in replicate and averaged. In some embodiments, break strength and/or flexibility may be determined with an unpigmented acrylic composition of the present invention and/or an unpigmented comparative composition, e.g., by comparing the compositions and/or one or more properties thereof.

In some embodiments, the break strength and/or flexibility of an acrylic composition of the present invention (e.g., a fabric) varies by about 0% or by less than about ±50%, 45%, 40%, 35%, 30%, 25%, 20%, 15%, 10%, 5%, or 1% after a period of time and/or after exposure to certain conditions compared to the initial break strength and/or flexibility of the acrylic composition. In some embodiments, an acrylic composition of the present invention (e.g., fabric) has a break strength and/or flexibility that varies by about 0% or by less than about ±50%, 45%, 40%, 35%, 30%, 25%, 20%, 15%, 10%, 5%, or 1% at about 3, 6, 9, or 12 months or 5 or 10 years (e.g., 3, 6, 9, or 12 months or 5 or 10 years of outdoor exposure) and/or after exposure to 880, 1320, or 2200 kJ in accordance with AATCC 169 Option 3.

In some embodiments, an acrylic composition may be in the form of a fiber and/or yarn, such as, e.g., a yarn having a 18/2 Ring Spun Cotton Count, and may have a break strength in a range of about 2 lbs/breaking force to about 4 lbs/breaking force, such as, e.g., 2.3 to 3.8 lbs/breaking force, optionally on average, and/or an elongation in a range from about 20% to about 30%, optionally on average. In some embodiments, a fiber and/or yarn may have a break strength of about 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, or 4 lbs/breaking force, optionally on average, and/or an elongation of about 20%, 21%, 22%, 23%, 24%, 25%, 26%, 27%, 28%, 29%, or 30%, optionally on average. Break strength and/or elongation may be measured using methods known to those of skill in the art, such as, e.g., using an Uster Tensojet. In some embodiments, break strength and/or elongation of a fiber and/or yarn may be measured using a rate of speed of about 12 inches per minute, optionally using an Instron® system.

In some embodiments, an acrylic composition may be in the form of a fiber and the fiber may have a tenacity in a range of about 30 to about 50. In some embodiments, the fiber may have a tenacity of about 30, 31, 32, 33, 34, 35, 36, 37, 38, 39, 40, 41, 42, 43, 44, 45, 46, 47, 48, 49, or 50. Tenacity may be measured using methods known to those of skill in the art, such as, e.g., in accordance with EN ISO 5079 (ISO 5079:1995 “Textile fibres—Determination of breaking force and elongation at break of individual fibres”), optionally using a Textechno Fafegraph HR+Textechno Vibromat ME.

An acrylic composition of the present invention may have reduced or no acrylonitrile polymer degradation compared to a current commercial acrylic composition of the same form (e.g., a current commercial acrylic fabric) and/or a control composition of the same form (e.g., a fabric without a hindered amine light stabilizer). In some embodiments, acrylonitrile polymer degradation may be measured and/or determined by measuring and/or determining the amount of low molecular weight chains present in the acrylic composition after a period of time and/or after exposure to certain conditions compared to the initial amount of low molecular weight chains present in the acrylic composition. In some embodiments, acrylonitrile polymer degradation may be measured and/or determined by measuring and/or determining the amount of a moiety, functional group, and/or impurity present in the acrylic composition after a period of time and/or after exposure to certain conditions compared to the initial amount of the moiety, functional group, and/or impurity present in the acrylic composition. In some embodiments, the moiety, functional group, and/or impurity may be a degradation product resulting from attack on the polymer (e.g., polymer backbone) by oxygen and/or a nucleophilic agent, a degradation product resulting from a hydrolysis and/or oxidation reaction, and/or may be the result and/or product of a β-ketonitrile defect in the polymer chain (e.g., one introduced during polymerization). In some embodiments, the moiety, functional group, and/or impurity may comprise a double bond. In some embodiments, polymer degradation (e.g., the formation of low molecular weight chains present in the acrylic composition) may be measured and/or determined upon initial formation of the composition and at about 1, 2, 3, 4, 5, 6, 7, 8, 9, 10, 11, 12, 13, 14, 15, 16, 17, 18, 19, 20, 21, 22, 23, 24 month(s) or year(s) or more after initial formation of the composition and/or after exposure to certain conditions, such as, but not limited to, real world outdoor conditions (e.g., in California, Arizona and/or Texas), sun exposure, heat exposure, and/or conditions in accordance with AATCC 169 Option 3. In some embodiments, improvements in polymer degradation of an acrylic composition of the present invention compared to a comparative composition may be determined by comparing the tensile strength, break strength, and/or flexibility of the compositions. In some embodiments, polymer degradation may be determined with an unpigmented acrylic composition of the present invention and/or an unpigmented comparative composition, e.g., by comparing the compositions and/or one or more properties thereof. Methods known to those of skill in the art including, but not limited to, Fourier-transform infrared spectroscopy (FTIR), Gas chromatography-mass spectrometry (GCMS), surface techniques, microscopy, and/or molecular weight analysis may be used to determine and/or measure polymer degradation.

In some embodiments, an acrylic composition of the present (e.g., fabric) has a thermal stability that is increased by at least 5% (e.g., about 10%, 15%, 20%, 25%, 30%, or more) compared to a current commercial acrylic composition of the same form (e.g., a current commercial acrylic fabric) and/or a control composition of the same form (e.g., a fabric without a hindered amine light stabilizer). The thermal stability may be measured and/or determined upon initial formation of the composition and/or at about 1, 2, 3, 4, 5, 6, 7, 8, 9, 10, 11, 12, 13, 14, 15, 16, 17, 18, 19, 20, 21, 22, 23, 24 month(s) or year(s) or more after initial formation of the composition and/or after exposure to certain conditions, such as, but not limited to, real world outdoor conditions (e.g., in California, Arizona and/or Texas), sun exposure, heat exposure, and/or conditions in accordance with AATCC 169 Option 3. In some embodiments, the acrylic composition has a thermal stability that is increased by at least 5%, 10%, 15%, or 20% at about 3, 6, 9, or 12 months or 5 or 10 years (e.g., 3, 6, 9, or 12 months or 5 or 10 years of outdoor exposure) and/or after exposure to 880, 1320, or 2200 kJ in accordance with AATCC 169 Option 3 compared to a comparative composition. In some embodiments, improvements in thermal stability of an acrylic composition of the present invention compared to a comparative composition may be determined by comparing the tensile strength, break strength, and/or flexibility of the compositions. In some embodiments, thermal stability may be determined with an unpigmented acrylic composition of the present invention and/or an unpigmented comparative composition, e.g., by comparing the compositions and/or one or more properties thereof.

An acrylic composition of the present invention may have reduced or no photooxidation compared to a current commercial acrylic composition of the same form (e.g., a current commercial acrylic fabric) and/or a control composition of the same form (e.g., a fabric without a hindered amine light stabilizer). In some embodiments, photooxidation may be measured and/or determined by measuring and/or determining the amount of a moiety, functional group, and/or impurity present in the acrylic composition after a period of time and/or after exposure to certain conditions compared to the initial amount of the moiety and/or functional group present in the acrylic composition. In some embodiments, the moiety, functional group, and/or impurity may comprise a double bond. In some embodiments, photooxidation may be measured and/or determined upon initial formation of the composition and at about 1, 2, 3, 4, 5, 6, 7, 8, 9, 10, 11, 12, 13, 14, 15, 16, 17, 18, 19, 20, 21, 22, 23, 24 month(s) or year(s) or more after initial formation of the composition and/or after exposure to certain conditions, such as, but not limited to, real world outdoor conditions (e.g., in California, Arizona and/or Texas), sun exposure, heat exposure, and/or conditions in accordance with AATCC 169 Option 3. In some embodiments, improvements in photooxidation of an acrylic composition of the present invention compared to a comparative composition may be determined by comparing the tensile strength, break strength, and/or flexibility of the compositions. In some embodiments, photooxidation may be determined with an unpigmented acrylic composition of the present invention and/or an unpigmented comparative composition, e.g., by comparing the compositions and/or one or more properties thereof. Methods known to those of skill in the art including, but not limited to, FTIR, GCMS, surface techniques, microscopy, and/or molecular weight analysis may be used to determine and/or measure photooxidation.

At least two types of degradation may be found in an acrylic composition (e.g., an acrylic fabric) when used in outdoor applications. These forms of degradation can be related to the pigments used for coloration in the solution dyeing process and/or base polymer degradation. Pigment selection can be important to achieve the needed color fastness for outdoor textile end uses. Pigments are often selected and tested in several accelerated weathering test methods to indicate performance. Examples of these tests can include SAE J2527 (SAE J2527 “Performance Based Standard for Accelerated Exposure of Automotive Exterior Materials Using a Controlled Irradiance Xenon-Arc Apparatus” J2527_200402, Issued: Feb. 11, 2004), which is a simulation of Florida weather, and AATCC 169 Option 3, which is representative of Arizona conditions. As one of skill in the art will recognize, after the selection of proper pigments, there are several steps which are needed to prepare the pigments prior to injection into the polymer stream and subsequent fiber formation to create long lasting outdoor products.

Polymer degradation can manifest itself in two ways: strength retention and discoloration. Strength retention can be measured after accelerated weathering or outdoor exposure using a common tensile test in both the machine and cross machine direction of the fabric structure. Even through an acrylic composition may lose some tensile strength after time, it is still far superior to other commonly used products made from olefins and/or polyester, which are different in chemical composition. In view of this superiority, often acrylics will last for 5 or more years outdoors in a variety of environments. However, some ecru acrylic fibers and/or fabrics may have more degradation compared to pigmented acrylics since pigmented packages are not incorporated into the polymer.

The second way that polymer degradation can be observed is in the discoloration of the composition. In hot and high UV conditions, an acrylic composition (e.g., fiber and/or fabric) may turn a shade of yellow to light brown as the composition is degraded. Test methods such as, e.g., AATCC 169 Option 3, can be used to observe and/or measure both strength retention and polymer discoloration.

When exposed to UV light in the 300 nm-400 nm range, the light (energy) can be absorbed by chromophores, which can create photochemical reactions in the polymer, resulting in functional groups and/or impurities in the acrylic composition (e.g., fiber and/or fabric). The degree of polymer degradation can depend on the environment the acrylic composition is exposed to. One common method of color change may happen as a carbon nitrogen triple bond is excited through irradiation of UV energy. “Color change” as used herein refers to a change in color of any kind, such as, e.g., in lightness, hue, and/or chroma. According to aspects of the present invention, in some embodiments, a hindered amine light stabilizer may function as a radical scavenger, e.g., using a cyclic regeneration of nitrile mechanism. A hindered amine light stabilizer may interact with a detrimental free radical and may not attract hydrogen present in the acrylonitrile polymer backbone. In some embodiments, a hindered amine light stabilizer may only interact with a detrimental free radical. Oxygen may react within the acrylonitrile polymer backbone to create hydrogen peroxides which may also degrade the acrylonitrile polymer chain. In some embodiments, a hindered amine light stabilizer may function to remove or attract hydrogen peroxide and/or precursors thereof

Discoloration (e.g., yellowing or browning) of the acrylonitrile polymer may be due to a new chromophore being formed, optionally after a certain number double bonds are created in the polymer structure. Alternatively or in addition, discoloration and/or polymer degradation may be seen after chain scissoring within the acrylonitrile polymer. The degree of discoloration may be influenced by the comonomer optionally present in the acrylic composition. Comonomers such as, but not limited to, methacrylate, methyl methacrylate and vinyl acetate, contain ester(s) which can be prone to degradation. Accordingly, it was surprisingly discovered that acrylic compositions of the present invention including a poly(acrylonitrile-co-methyl acrylate), which contains esters, may have reduced or no acrylonitrile polymer degradation and/or discoloration compared to a current commercial acrylic composition of the same form (e.g., a current commercial acrylic fabric) and/or a control composition. In some embodiments, an acrylic composition of the present invention includes a poly(acrylonitrile-co-methyl acrylate) that comprises two or more different comonomer(s) that each contain an ester.

Any suitable method may be used to determine and/or measure the improved and/or positive effects of adding and/or incorporating a hindered amine light stabilizer into an acrylic composition of the present invention. In some embodiments, GC-MS and/or FTIR analysis may be used to confirm improved stability before and/or after weathering and/or after exposure to certain conditions. In some embodiments, an acrylic composition may be tested in accordance with AATCC 169 Option 3 for color change in light pigmented shades and/or unpigmented fibers. In some embodiments, tensile strength testing of an acrylic composition may be performed after exposure to conditions in accordance with AATCC Option 3 compared to a control composition exposed to the same conditions.

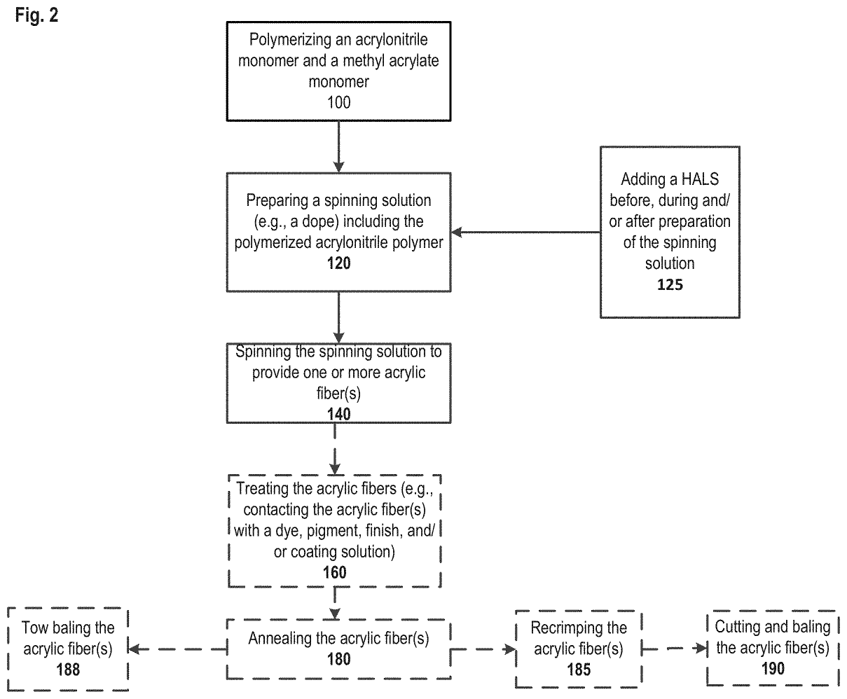

As one of ordinary skill in the art will recognize, acrylic fiber can be produced via several different production methods. Any suitable production method may be used in a method of the present invention. An overview of an example acrylic process is provided in FIG. 2. In general, a method for producing an acrylic fiber can be divided into the following steps: polymerization, production of a spinning solution, fiber spinning, and optional post-treatments. As shown in FIG. 2, a method of the present invention may comprise polymerizing (e.g., by free radical polymerization) an acrylonitrile monomer and a methyl acrylate monomer (block 100). A spinning solution (e.g., a dope) may be prepared that includes the polymerized acrylonitrile polymer (block 120), and before, during, and/or after preparation of the spinning solution a hindered amine light stabilizer (HALS) may be added to the poly(acrylonitrile-co-methyl acrylate) (block 125). In some embodiments, prior to fiber spinning, the poly(acrylonitrile-co-methyl acrylate) may be solubilized into a dope using a suitable solvent and a HALS may be added to the dope. The spinning solution may then be spun (e.g., extruded) using a spinning process to provide one or more acrylic fiber(s) (block 140). As one of ordinary skill in the art will recognize a spinning process (e.g., a wet or dry spinning process) can involve passing the spinning solution through a spinneret to spin (e.g., extrude) an acrylic fiber. The acrylic fiber(s) may then be treated and/or go through one or more post-processing steps. In some embodiments, the acrylic fiber(s) may be treated (block 160), such as, e.g., contacting the acrylic fiber(s) with a dye, pigment, finish, and/or coating solution, optionally during the spinning step (block 140). The acrylic fiber(s) may be annealed (block 180). In some embodiments, the acrylic fibers may be tow baled (block 188). Alternatively, the acrylic fibers may be recrimped (block 185) and/or cut and baled (block 190).

“Dope” as used herein refers to a homogeneous solution comprising a poly(acrylonitrile-co-methyl acrylate), one or more (e.g., 1, 2, 3, 4, or more) solvent(s), and optionally one or more (e.g., 1, 2, 3, 4, or more) additive(s). Example solvents that may be used in a dope include, but are not limited to, dimethylformamide, dimethylacetamide, and/or dimethyl sulfoxide. In some embodiments, the solvent is a polar organic solvent. In some embodiments, the solvent is a dipolar aprotic solvent. In some embodiments, the dope is devoid of a benzophenone, hydroxyphenylbenzotriazole, and/or UV absorber. In some embodiments, a dope may have a composition as provided in Table 1.

TABLE 1
Exemplary dope compositions.

| | % of poly(acrylonitrile- |
|---|---|
| | co-methyl acrylate) |
| Solvent present in the dope | in the dope |
| Dimethylformamide | 28%-32% |
| Dimethylacetamide | 22%-27% |
| Aqueous Sodium thiocyanate | 10%-15% |
| Aqueous Zinc Chloride | 8%-12% |
| Dimethyl sulfoxide | 20%-25% |
| Nitric Acid | 8%-12% |

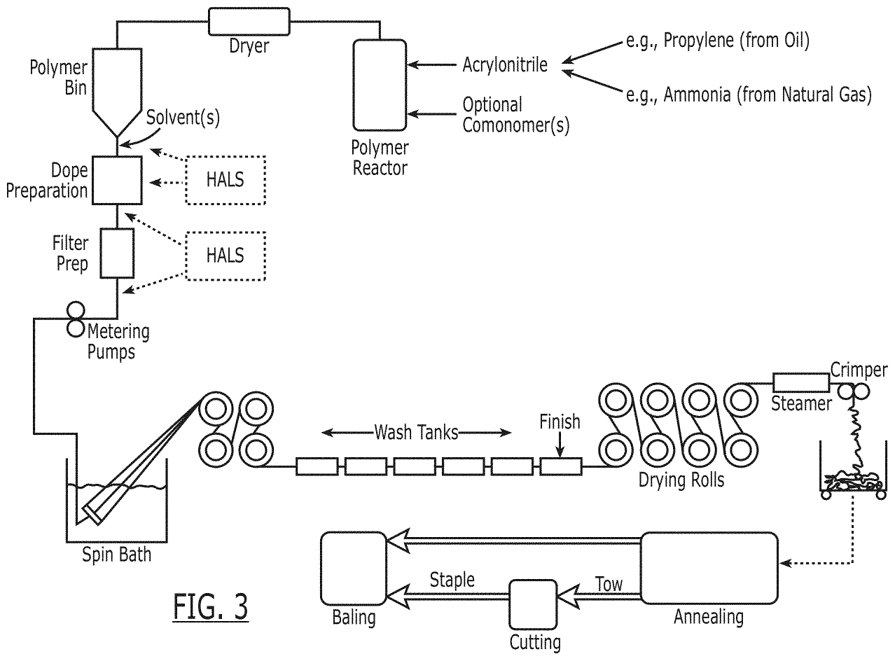

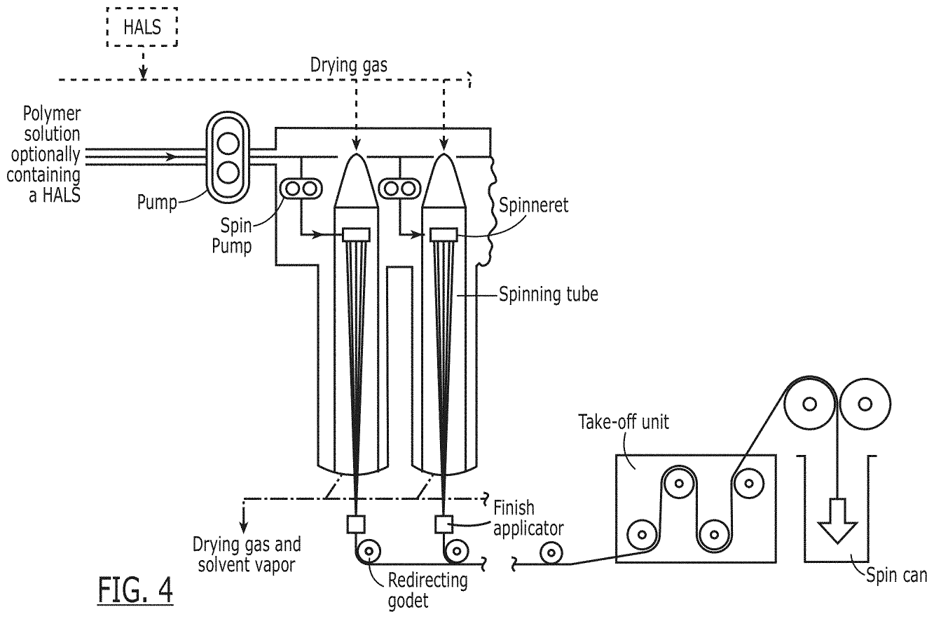

Once the dope has been created, optionally one or more additive(s) and/or pigment(s) may be injected into the dope and/or a dope stream, and may be mixed prior to the fiber spinning process. A spinneret may be used to form an acrylic fiber as the dope (e.g., viscous dope) moves through one or more hole(s) of the spinneret. In the case of wet spinning, an acrylic fiber may begin to form in a coagulation bath, which may contain both water and a solvent (e.g., an organic solvent). Gelation of the acrylic fiber occurs as the solvent present in the acrylic fiber begins to move from the acrylic fiber. An example wet spinning process is shown in FIG. 3. In some embodiments, a hindered amine light stabilizer may be added during and/or after dope preparation and/or prior to the polymer solution reaching the metering pumps as shown in FIG. 3. In the case of dry spinning, fiber formation occurs through evaporation of the solvent present in the acrylic fiber as the dope exits the spinneret in a heated spinning tube. An example dry spinning process is shown in FIG. 4. In some embodiments, a hindered amine light stabilizer may be present in the polymer solution and/or added into the polymer solution prior to drying as shown in FIG. 4. Subsequent processes can involve washing, stretching and/or drying of a tow band under specific conditions to create the desired fiber properties for the end-use application. The resultant product may be, but is not limited to, cut staple fiber, tow, or multifilament yarn depending on the desired finished good.

In some embodiments, a method of the present invention may comprise one or more post-treatments. Any suitable post-treatment may be used in a method of the present invention. In some embodiments, an acrylic fiber is contacted with a finishing and/or coating treatment known to those of skill in the art, such as, e.g., contacted with a fluorinated compound and/or polymer.

According to some embodiments of the present invention, a method of preparing an acrylic fiber is provided, the method comprising: combining a hindered amine light stabilizer and a poly(acrylonitrile-co-methyl acrylate) to provide a stabilized acrylic composition; and forming an acrylic fiber from the stabilized acrylic composition, thereby preparing the acrylic fiber. In some embodiments, combining the hindered amine light stabilizer and poly(acrylonitrile-co-methyl acrylate) comprises adding the hindered amine light stabilizer to a poly(acrylonitrile-co-methyl acrylate) or vice versa. In some embodiments, forming the acrylic fiber from the stabilized acrylic composition comprises spinning, extruding, and/or the like the stabilized acrylic composition to form the acrylic fiber.

In some embodiments, a hindered amine light stabilizer may be selected based on basicity of the hindered amine light stabilizer (e.g., one with low basicity), migration of the hindered amine light stabilizer in an acrylic composition (e.g., one that provides low migration), durability of the hindered amine light stabilizer in an acrylic composition (e.g., one that provides high durability), and/or heat stability of the hindered amine light stabilizer in an acrylic composition (e.g., one that provides high and/or long term heat stability). As described herein, example hindered amine light stabilizers include, but are not limited to, Tinuvin® 622, Tinuvin® 123, Tinuvin® 111, Tinuvin® 371, Chimassorb® 2020, Chimassorb® 944 and/or Cyasorb® 3529.

In some embodiments, combining a hindered amine light stabilizer and a poly(acrylonitrile-co-methyl acrylate) comprises combining the hindered amine light stabilizer and the poly(acrylonitrile-co-methyl acrylate) prior to, during, and/or after a solubilization step and/or a fiber spinning step. Referring to FIG. 2, the combining may occur after a polymerization step and prior to, during, and/or after dope preparation, and/or prior to and/or during fiber spinning. In some embodiments, a hindered amine light stabilizer is combined with a poly(acrylonitrile-co-methyl acrylate) prior to, during, and/or after a solubilization step, optionally with, at the same time as, or sequentially with one or more additive(s) and/or pigment(s). A pigment and/or additive may be combined with (e.g., added to) a poly(acrylonitrile-co-methyl acrylate) prior to, during and/or after the combining of the hindered amine light stabilizer and poly(acrylonitrile-co-methyl acrylate). In some embodiments, a composition comprising a hindered amine light stabilizer and one or more additive(s) and/or pigment(s) is added to the poly(acrylonitrile-co-methyl acrylate). In some embodiments, a pigment and/or additive is separately added to the poly(acrylonitrile-co-methyl acrylate), optionally at the same time as a hindered amine light stabilizer.

In some embodiments, a hindered amine light stabilizer is combined with a poly(acrylonitrile-co-methyl acrylate) once a dope has been created, and the hindered amine light stabilizer may be injected into the dope and/or a dope stream optionally with one or more additive(s) and/or pigment(s). The dope containing the hindered amine light stabilizer may be mixed and then may go through a fiber spinning step. The method may comprise a wet spinning or dry spinning fiber manufacturing process.

One or more (e.g., 1, 2, 3, 4, 5, or more) hindered amine light stabilizer(s) as described herein may be combined with a poly(acrylonitrile-co-methyl acrylate) at any suitable concentration. In some embodiments, one or more hindered amine light stabilizer(s) may be combined with a poly(acrylonitrile-co-methyl acrylate) in any suitable form (e.g., dry form (e.g., a powder) and/or in liquid form (e.g., a solution)). In some embodiments, a hindered amine light stabilizer may be combined with a poly(acrylonitrile-co-methyl acrylate) at a concentration greater than or equal to the desired concentration for the hindered amine light stabilizer in the acrylic composition. For example, a hindered amine light stabilizer may be present in an acrylic fiber in an amount in a range from about 0.01% to about 10% by weight of an acrylic fiber.

In some embodiments, the stabilized poly(acrylonitrile-co-methyl acrylate) composition comprises the hindered amine light stabilizer (HALS) at a concentration in a range of about 0.01%, 1%, or 5% to about 10%, 20%, or 30% by weight of the stabilized poly(acrylonitrile-co-methyl acrylate) composition. In some embodiments, a hindered amine light stabilizer may be present in the stabilized poly(acrylonitrile-co-methyl acrylate) composition at a concentration of about 0.01%, 0.05%, 0.1%, 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30% by weight of the stabilized poly(acrylonitrile-co-methyl acrylate) composition. In some embodiments, a hindered amine light stabilizer is added to a dope and/or solvent, e.g., at a concentration in a range of about 0.01%, 1%, or 5% to about 10%, 20%, or 30% by weight of the dope and/or solvent. A hindered amine light stabilizer used in a method and/or acrylic composition of the present invention may be compatible with, dissolved in, and/or soluble in a dope and/or solvent used in a method of the present invention. The solvent may be and/or the dope may comprise a polar solvent.

In some embodiments, a hindered amine light stabilizer (e.g., in powder form) may be prepared in a manner similar to a pigment for a solution dyeing process. This may involve use of a dope solution and mixing system. Once premixing has occurred, the solution may be milled to a given particle size and/or evenness of the material. In some embodiments, a poly(acrylonitrile-co-methyl acrylate) may be mixed with a solution comprising a hindered amine light stabilizer and optionally an additive and/or pigment, which may aid in dispersing the solution during injection. In some embodiments, a hindered amine light stabilizer may be added directly into a solution (e.g., a solvent) without the presence of a poly(acrylonitrile-co-methyl acrylate), and this may involve mixing to provide adequate solubility. In some embodiments, a solution comprising a hindered amine light stabilizer may be filtered and/or the viscosity of the solution may be determined. A solution comprising a hindered amine light stabilizer may be stored in a container or reservoir (e.g., a tote), optionally with a circulation system or proper mixing apparatus.

A method of the present invention may further comprise forming a yarn, thread, and/or fabric from the acrylic fiber. Any suitable method for forming the yarn, thread, and/or fabric from the acrylic fiber may be used. In some embodiments, a method of the present invention comprises weaving an acrylic fiber and/or yarn into an acrylic fabric. Any suitable weave may be used, including, but not limited to, a plain weave, twill weave, leno weave, dobby weave, jacquard weave, and/or satin weave.

A method of the present invention may provide and/or produce an acrylic fiber and/or fabric comprising the same having one more improved properties, such as, but not limited to, those described herein (e.g., reduced polymer degradation and/or reduced discoloration) compared to a comparative fiber and/or fabric comprising the comparative fiber. In some embodiments, a method of the present invention may produce an acrylic fiber and/or fabric for outdoor end use and/or that is suitable for outdoor use, optionally wherein the acrylic fiber and/or fabric has improved properties, such as, e.g., reduced polymer degradation and/or reduced discoloration.

In some embodiments, a hindered amine light stabilizer is combined with (e.g., added to) a poly(acrylonitrile-co-methyl acrylate) after polymerization of the poly(acrylonitrile-co-methyl acrylate) and prior to fiber spinning. The hindered amine light stabilizer may be added (e.g., injected) into a dope (e.g., at a concentration of about 0.01% to about 30% by weight of the dope), optionally in a manner similar to a pigment (e.g., by using a metering pump) to provide a stabilized acrylic composition. The hindered amine light stabilizer may be in a solution, such as, e.g., a solution comprising a solvent and the hindered amine light stabilizer. In some embodiments, the hindered amine light stabilizer is added to a portion of a dope, which may then be added to the remaining portion of the dope and/or a dope fiber stream. After being added to (e.g., injected into) the dope and/or a dope fiber stream, the stabilized acrylic composition may be mixed (e.g., with a long mixing screw), which may disperse the hindered amine light stabilizer within the stabilized acrylic composition prior to spinning. The stabilized acrylic composition may then be extruded (e.g., through a spinneret) and phase separated into a gel in a wet spinning bath (i.e., a coagulation bath) comprising water and solvent (e.g., in a given ratio). Better fine fiber structures may be provided in a coagulation bath with a higher solvent to water ratio and reduced temperatures. These properties can slow the phase change as the fiber is being formed. An example coagulation bath may comprise about 60% DMAc and about 40% water and may be at a temperature of about 45° C. with a spin dope temperature of less than 120° C. In some embodiments, a spinneret may have about 10,000 to about 60,000 holes. Fiber spinning may likely occur at about 3 meters/min to about 10 meters/min.

In some embodiments, addition of a hindered amine light stabilizer may be completed prior to injection into a dope stream. The hindered amine light stabilizer may be diluted in a solvent, which may aid in providing a constant and/or consistent feeding through a metering pump. Dispersion and/or runnability issues may occur if the concentration of the hindered amine light stabilizer is too high and/or viscous. These issues may manifest as clogging of the spinneret holes.

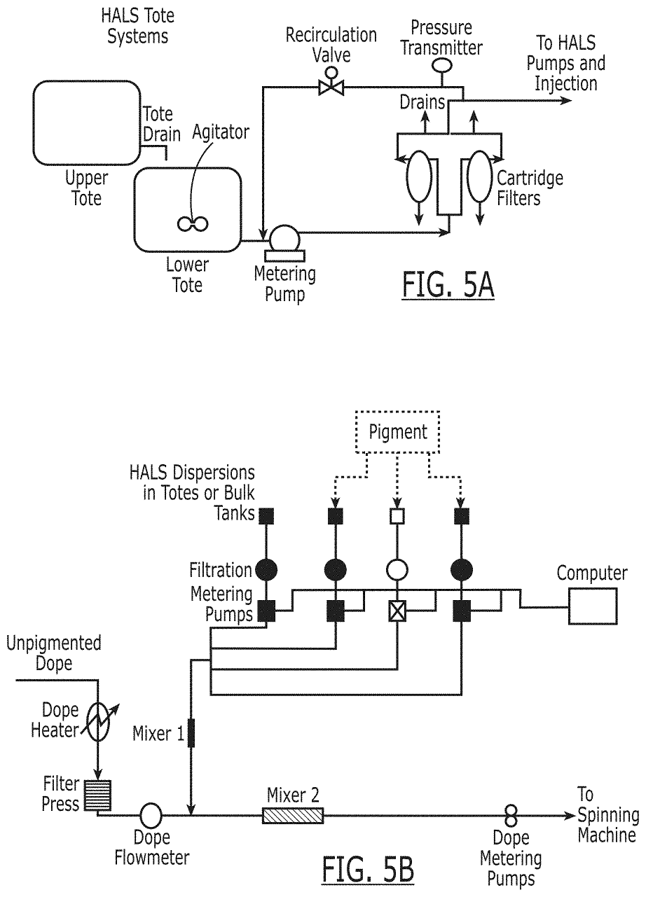

Referring now to FIGS. 5A and 5B, a hindered amine light stabilizer may be combined with a poly(acrylonitrile-co-methyl acrylate) to provide a stabilized acrylic composition prior to fiber spinning via injection in a solution dyeing process (similar to pigment addition). As shown in FIG. 5A, a tote or master line can transport a hindered amine light stabilizer (e.g., a solution containing the hindered amine light stabilizer) to the injection site prior to a mixing screw. As shown in FIG. 5B, the hindered amine light stabilizer and optionally one or more pigments may then be dosed into the polymer stream from the tote or master line, then mixed and filtered for consistency. In some embodiments, the hindered amine light stabilizer may be selectively added to given batches of a poly(acrylonitrile-co-methyl acrylate).

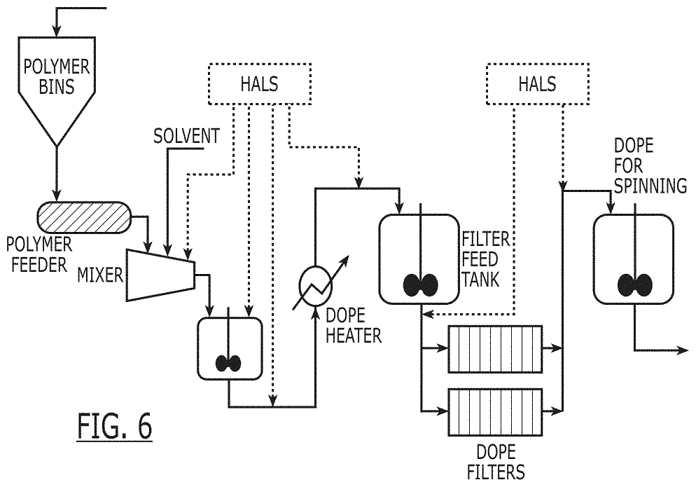

Referring now to FIG. 6, prior to and/or during fiber spinning, a hindered amine light stabilizer may be added to a poly(acrylonitrile-co-methyl acrylate) at one or more steps in a process of preparing a dope to provide a stabilized acrylic composition. In some embodiments, the HALS may be added to the poly(acrylonitrile-co-methyl acrylate) at the same time as the solvent and/or may be present in the solvent. In some embodiments, the HALS may be added to the poly(acrylonitrile-co-methyl acrylate) after the solvent is added, such as, e.g., during mixing of the dope and/or prior to, during, and/or after heating and/or filtering of the dope. In some embodiments, the HALS may be added to the dope prior to and/or during fiber spinning. The dope may comprise the poly(acrylonitrile-co-methyl acrylate), one or more solvent(s), and optionally one or more additive(s) (e.g., antioxidant(s)) and/or pigment(s)).

The present invention is explained in greater detail in the following non-limiting examples.

### EXAMPLES

### Example 1

Different HALS were separately combined with poly(acrylonitrile-co-methyl acrylate) in DMF to provide a HALS composition. The HALS included Tinuvin® 622 having a pKa of 6.8, Chimassorb® 2020 having a pKa of 9.7 and Chimassorb® 944 having a pKa of 9.7. No pigment was included in the HALS compositions.

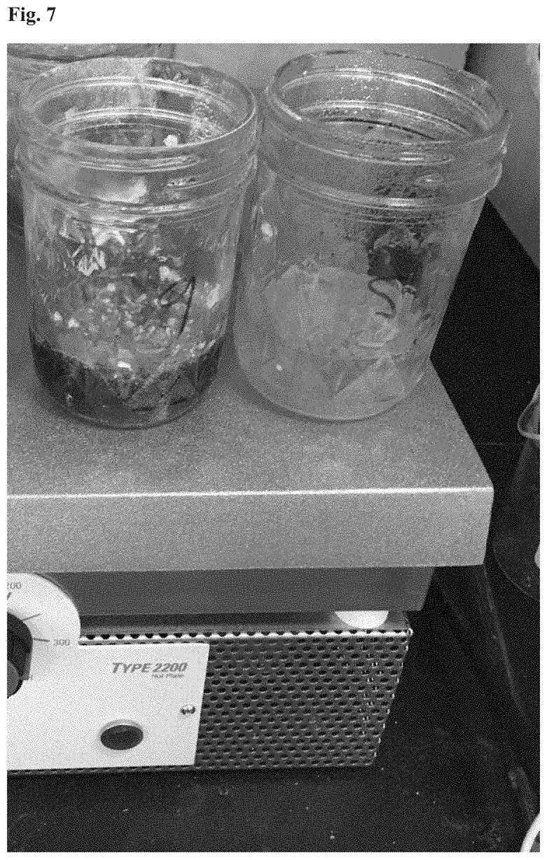

A control composition was also prepared, which included the poly(acrylonitrile-co-methyl acrylate) and DMF and did not include a HALS or pigment. The control composition had a translucent light yellow color. Previously, it was discovered that if a HALS composition differed significantly in color from the control composition (e.g., had a darker yellow color, an orange color, and/or a brown color), then an acrylic fiber produced from such a composition would be yellowish in color rather than ecru and/or a fabric including the acrylic fiber would not have a Gray scale value of 5 after exposure to about 50 kJ to about 150 kJ of light. Often a HALS composition that was amber in color would provide an acrylic fiber having a yellowish color and/or a fabric including the acrylic fiber would not have a Gray scale value of 5 after exposure to about 50 kJ to about 150 kJ of light. An example of this can be seen in FIG. 7, which shows the amber color of a composition including poly(acrylonitrile-co-vinyl acetate), Chimassorb® 944, and DMF (left container) compared to the yellow color of a composition including poly(acrylonitrile-co-vinyl acetate), Tinuvin® 622, and DMF (right container). Without wishing to be bound to any particular theory, the discoloration in a HALS composition compared to the control composition is believed to be caused by dehydrogenation of the polyacrylonitrile polymer such that a double bond is formed in the polymer as shown in Scheme 1.

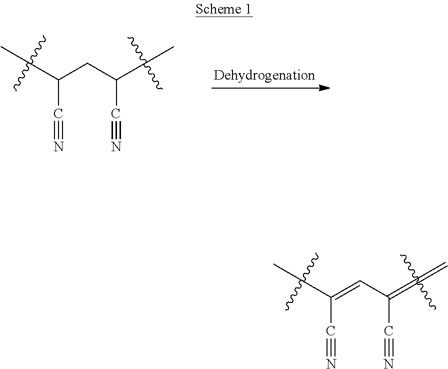 [SMILES: *C(C#N)CC(*)C#N ; */C(C#N)=C/C(=*)C#N]

HALS compositions including DMF, poly(acrylonitrile-co-methyl acrylate), and Chimassorb® 2020 or Chimassorb® 944 had less discoloration (e.g., yellowing) compared to a HALS composition including DMF, poly(acrylonitrile-co-vinyl acetate), and Chimassorb® 2020 or Chimassorb® 944.

### Example 2

Poly(acrylonitrile-co-methyl acrylate) was combined with Chimassorb® 944 in DMF to provide a HALS composition. The concentration of Chimassorb® 944 was 1% based on the weight of the acrylic fiber. Control compositions were also prepared, which included poly(acrylonitrile-co-methyl acrylate) and DMF, and the acrylic fibers formed therefrom did not include a HALS. Accelerated weathering tests were performed on the treated and control samples. The results are shown in Tables 2-5.

TABLE 2
Cadet Grey (control)

| Color Name/Number: | Cadet Grey (control) | |
|---|---|---|
| Fiber/Yarn Type: | Acrylic | |
| Lot Number: | 85-2-11396 | |
| AATCC 169-3 Test Results | Rating | Delta E |
| 880 kJ | 4 | 1.94 |
| 1320 kJ | 3-4 | 3.07 |
| 2200 kJ | 2-3 | 5.48 |

TABLE 3
Cadet Grey (control)

| Color Name/Number: | Cadet Grey (control) | |
|---|---|---|
| Fiber/Yarn Type: | Acrylic | |
| Lot Number: | 85-2-11555 | |
| AATCC 169-3 Test Results | Rating | Delta E |
| 880 kJ | 4 | 1.52 |
| 1320 kJ | 3-4 | 2.66 |
| 2200 kJ | 3 | 4.91 |

TABLE 4
Cadet Grey (with 1% Chimassorb ® 944)

| Color Name/Number: | Cadet Gray w/ HALS | |
|---|---|---|
| Fiber/Yarn Type: | Acrylic | |
| Control/Style Number: | C#88490 | |
| Machine Type/#: | Ci5000/3 | |
| AATCC 169-3 Test Results | Rating | Delta E |
| 880 kJ | 4-5 | 0.66 |
| 1320 kJ | 4-5 | 0.82 |
| 2200 kJ | 4-5 | 1.14 |

TABLE 5
Cadet Grey (with 1% Chimassorb ® 994)

| Color Name/Number: | Cadet Gray w/ HALS | |
|---|---|---|
| Fiber/Yarn Type: | Acrylic | |
| Control/Style Number: | C#88491 | |
| Machine Type/#: | Ci5000/3 | |
| AATCC 169-3 Test Results | Rating | Delta E |
| 880 kJ | 4-5 | 0.66 |
| 1320 kJ | 4-5 | 0.82 |
| 2200 kJ | 4-5 | 1.22 |

### Example 3

Poly(acrylonitrile-co-methyl acrylate) was combined with Chimassorb® 944 in DMF to provide a HALS composition and acrylic fibers were formed therefrom. The concentration of Chimassorb® 944 was 1% based on the weight of the acrylic fiber. Control compositions were also prepared, which included the poly(acrylonitrile-co-methyl acrylate) and DMF, and the acrylic fibers formed therefrom did not include a HALS. Accelerated weathering tests were performed on the treated and control samples. The results are shown in Tables 6-8.

TABLE 6
Antique Beige (control)

| Color Name/Number: | Antique Beige (control) | |
|---|---|---|
| Lot Number: | 85-2-09435 | |
| AATCC 169-3 Test Results | Rating | Delta E |
| 880 kJ | 4 | 1.26 |
| 1320 kJ | 4 | 1.81 |
| 2200 kJ | 3-4 | 2.89 |

TABLE 7
Antique Beige (control)

| Color Name/Number: | Antique Beige (control) | |
|---|---|---|
| Lot Number: | 85-2-09977 | |
| AATCC 169-3 Test Results | Rating | Delta E |
| 880 kJ | 4.5 | 0.72 |
| 1320 kJ | 4 | 1.52 |
| 2200 kJ | 3.5 | 2.54 |

TABLE 8
Antique Beige (treated)

| Color Name/Number: | Antique Beige w/ HALS | |
|---|---|---|
| Lot Number: | 85-2-12306 | |
| Machine Type/#: | Ci5000/1 | |
| AATCC 169-3 Test Results | Rating | Delta E |
| 880 kJ | 4-5 | 0.61 |
| 1320 kJ | 4-5 | 0.75 |
| 2200 kJ | 4-5 | 0.73 |

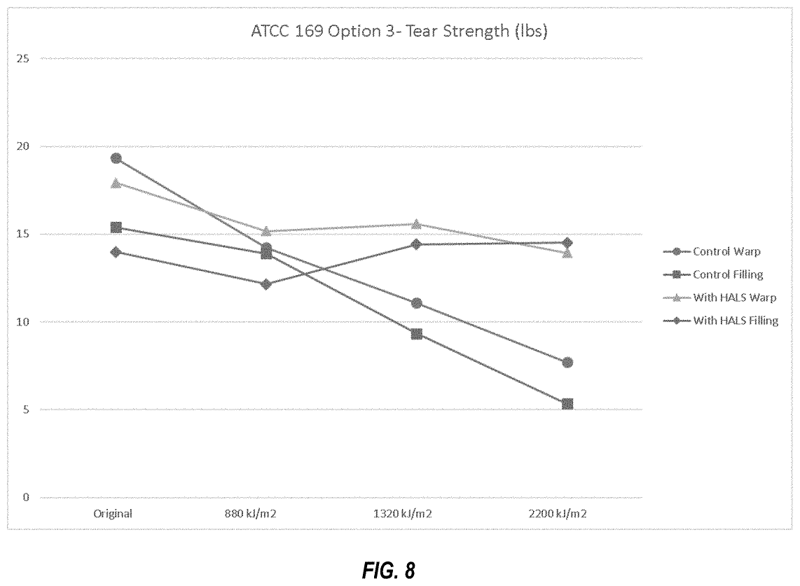

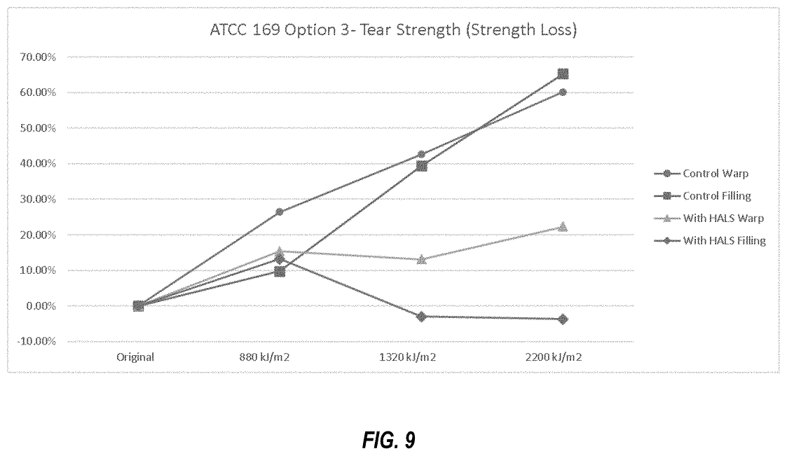

The fabric strength retention was also tested with the fabric being a 68 ends×32 picks plain weave acrylic fabric. The treated fibers (i.e., poly(acrylonitrile-co-methyl acrylate) fibers including Chimassorb® 944) showed improvement in both overall strength (FIG. 8), strength loss (FIG. 9), and after accelerated weathering. The results are also shown in Tables 9-11.

TABLE 9
AATCC 169-3 (WOM)
Fabric Strength Retention

| | | 880 | | 1320 | | 2200 | |
|---|---|---|---|---|---|---|---|
| Antique Beige Control | Original | kJ/m² | % Loss | kJ/m² | % Loss | kJ/m² | % Loss |
| Tear Strength (lbs) - Warp | 19.34 | 14.23 | 26.42% | 11.09 | 42.66% | 7.71 | 60.13% |
| Tear Strength (lbs) - Fill | 15.4 | 13.89 | 9.81% | 9.34 | 39.35% | 5.34 | 65.32% |
| Antique Beige w/HALS | | | | | | | |
| (C# 84355) | | | | | | | |
| Tear Strength (lbs) - Warp | 17.93 | 15.18 | 15.34% | 15.58 | 13.11% | 13.93 | 22.31% |
| Tear Strength (lbs) - Fill | 14 | 12.15 | 13.21% | 14.42 | −3.00% | 14.52 | −3.71% |

TABLE 10

| | Tear Strength (lbs) | | | |
|---|---|---|---|---|
| | | | With | With |
| | Control | Control | HALS | HALS |
| | Warp | Filling | Warp | Filling |
| Original | 19.34 | 15.4 | 17.93 | 14 |
| 880 kJ/m² | 14.23 | 13.89 | 15.18 | 12.15 |
| 1320 kJ/m² | 11.09 | 9.34 | 15.58 | 14.42 |
| 2200 kJ/m² | 7.71 | 5.34 | 13.93 | 14.52 |

TABLE 11

| | Tear Strength (Strength Loss) | | | |
|---|---|---|---|---|
| | Control | Control | With HALS | With HALS |
| | Warp | Filling | Warp | Filling |
| Original | 0.00% | 0.00% | 0.00% | 0.00% |
| 880 kJ/m² | 26.42% | 9.81% | 15.34% | 13.21% |
| 1320 kJ/m² | 42.66% | 39.35% | 13.11% | −3.00% |
| 2200 kJ/m² | 60.13% | 65.32% | 22.31% | −3.71% |

### Example 4

Poly(acrylonitrile-co-methyl acrylate) was combined with a 50:50 split of Chimassorb® 2020 and Chimassorb® 944 in DMF to provide a HALS composition and acrylic fibers were formed therefrom. The total concentration of Chimassorb® 2020 and Chimassorb® 944 was 1.25% based on the weight of the acrylic fiber. No pigment was included in the HALS compositions or acrylic fibers. Control compositions were also prepared, which included the poly(acrylonitrile-co-methyl acrylate) and DMF, and the acrylic fibers formed therefrom did not include a HALS or pigment. Accelerated weathering tests were performed on the treated and control samples. The results are shown in Tables 12-14, which show excellent performance for the treated samples.

TABLE 12
Natural (control)

| Color Name/Number: | Dry Spun Natural (control) | |
|---|---|---|
| Fiber/Yarn Type: | Acrylic Sock (scoured) | |
| Lot/Yarn Number: | 9-1-1564 | |
| Control/Style Number: | 69115 | |
| Machine Type/#: | Ci5000/3 | |
| AATCC 169-3 Test Results | Rating | Delta E |
| 880 kJ | 1 | 15.64 |
| 1320 kJ | 1 | 18.58 |
| 2200 kJ | 1 | 23.27 |

TABLE 13
Natural (control)

| Color Name/Number: | Dry Spun Natural (control) | |
|---|---|---|
| Fiber/Yarn Type: | Acrylic Sock | |
| Lot/Yarn Number: | 9-0999-7249 | |
| Control/Style Number: | 68429 | |
| Machine Type/#: | Ci5000/3 | |
| AATCC 169-3 Test Results | Rating | Delta E |
| 880 kJ | 1 | 14.51 |
| 1320 kJ | 1 | 17.54 |
| 2200 kJ | 1 | 21.26 |

TABLE 14
Natural (treated)
Color Name/Number: Dry spun w/HALS
Fiber/Yarn Type: Acrylic Sock
Control/Style Number: 88492
Machine Type/#: Ci5000/1

| AATCC 169-3 | | Delta E | | | |
|---|---|---|---|---|---|
| Test Results | Rating | (DE) | DL | Da | Db |
| 880 kJ | 4-5 | 0.85 | 0.05 | 0.1 | −0.7 |
| 1320 kJ | 4-5 | 0.37 | 0.72 | 0.15 | −0.15 |
| 2200 kJ | 4-5 | 0.86 | 0.13 | 0.16 | −0.68 |

Accelerated weathering tests were performed on acrylic fibers prepared from an acrylic composition including poly(acrylonitrile-co-vinyl acetate) and either a HALS with a pKa of about 9 or more or a pKa of about 7 or less (Tables 15 and 16). Accordingly, the acrylic fibers including poly(acrylonitrile-co-methyl acrylate) and Chimassorb® 2020 and Chimassorb® 944 provided improved properties compared the acrylic fibers including poly(acrylonitrile-co-vinyl acetate).

TABLE 15
Acrylic fibers including poly(acrylonitrile-co-vinyl
acetate) and a HALS with a pKa of about 9 or more

| AATCC 169-3 Test Results | DE | DL | Da | Db |
|---|---|---|---|---|
| 880 | 4.8 | 2.16 | 0.73 | −5.7 |
| 1320 | 4.76 | 1.97 | 0.73 | −5.66 |
| 2200 | 5.18 | 2.04 | 0.72 | −6.17 |

TABLE 16
Acrylic fibers including poly(acrylonitrile-co-vinyl
acetate) and a HALS with a pKa of about 7 or less

| AATCC 169-3 Test Results | DE | DL | Da | Db |
|---|---|---|---|---|
| 880 | 1.45 | 4.16 | 0.09 | −0.15 |
| 1320 | 1.48 | 4.41 | 0.01 | −0.12 |
| 2200 | 1.57 | 4.06 | 0.6 | −0.01 |

The foregoing is illustrative of the present invention, and is not to be construed as limiting thereof The invention is defined by the following claims, with equivalents of the claims to be included therein.

1. An acrylic fiber comprising:
a poly(acrylonitrile-co-methyl acrylate) having acrylonitrile units present in an amount of at least 85% by weight of the polymer; and
a hindered amine light stabilizer, wherein the hindered amine light stabilizer is within the acrylic fiber.

2. (canceled)

3. The acrylic fiber of claim 1, wherein the poly(acrylonitrile-co-methyl acrylate) comprises one or more additional comonomer units selected from the group consisting of vinyl acetate, vinyl chloride, vinylidene chloride, styrene, methyl methacrylate, vinyl acetate, sodium styrene sulfonate, sodium methallyl sulfonate, sodium sulfophenyl methallyl, ether, itaconic acid, and any combination thereof.

4. The acrylic fiber of claim 1, wherein the poly(acrylonitrile-co-methyl acrylate) has an average molecular weight in a range from about 40,000 g/mol to about 200,000 g/mol.

5. The acrylic fiber of claim 1, wherein the hindered amine light stabilizer is distributed throughout the acrylic fiber.

6. The acrylic fiber of claim 1, wherein the hindered amine light stabilizer has a pKa in a range from about 3 to about 11.

7. The acrylic fiber of claim 1, wherein the hindered amine light stabilizer has a number average molecular weight in a range from about 1000 g/mol to about 20,000 g/mol and/or the hindered amine light stabilizer has a molecular weight in a range from about 500 to about 4500 g/mol.

8. The acrylic fiber of claim 1, wherein the acrylic fiber, optionally when measured devoid of a pigment and optionally measured in the form of a fabric, has a Gray scale value of 4, 4-5, or 5; a DL value of about 0 to about 1; a Da value of about 0 to about 0.3; a Db value of about 0 to about −1; and/or a DE value of about 0.1 to about 2.5, after exposure to about 800 kJ to about 2500 kJ of light.

9. The acrylic fiber of claim 1, wherein the hindered amine light stabilizer has a water solubility at 20° C. of about 2% w/w or less.

10. The acrylic fiber of claim 1, wherein the hindered amine light stabilizer is an oligomeric hindered amine light stabilizer.

11. The acrylic fiber of claim 1, wherein the hindered amine light stabilizer comprises one or more (e.g., 2, 3, 4, or more) 2,2,6,6-tetraalkylpiperidinyl groups in the hindered amine light stabilizer or per repeating unit of the hindered amine light stabilizer

12. The acrylic fiber of claim 1, wherein the hindered amine light stabilizer is present in the fiber in an amount in a range from about 0.01 to about 10% by weight of the acrylic fiber.

13. The acrylic fiber of claim 1, wherein the hindered amine light stabilizer has a melting point in a range of about 70° C. to about 160° C.

14. The acrylic fiber of claim 1, wherein the acrylic fiber is devoid of a benzophenone, triazine, and/or hydroxyphenylbenzotriazole.

15. The acrylic fiber of claim 1, wherein the hindered amine light stabilizer comprises a structure of any one of the following: 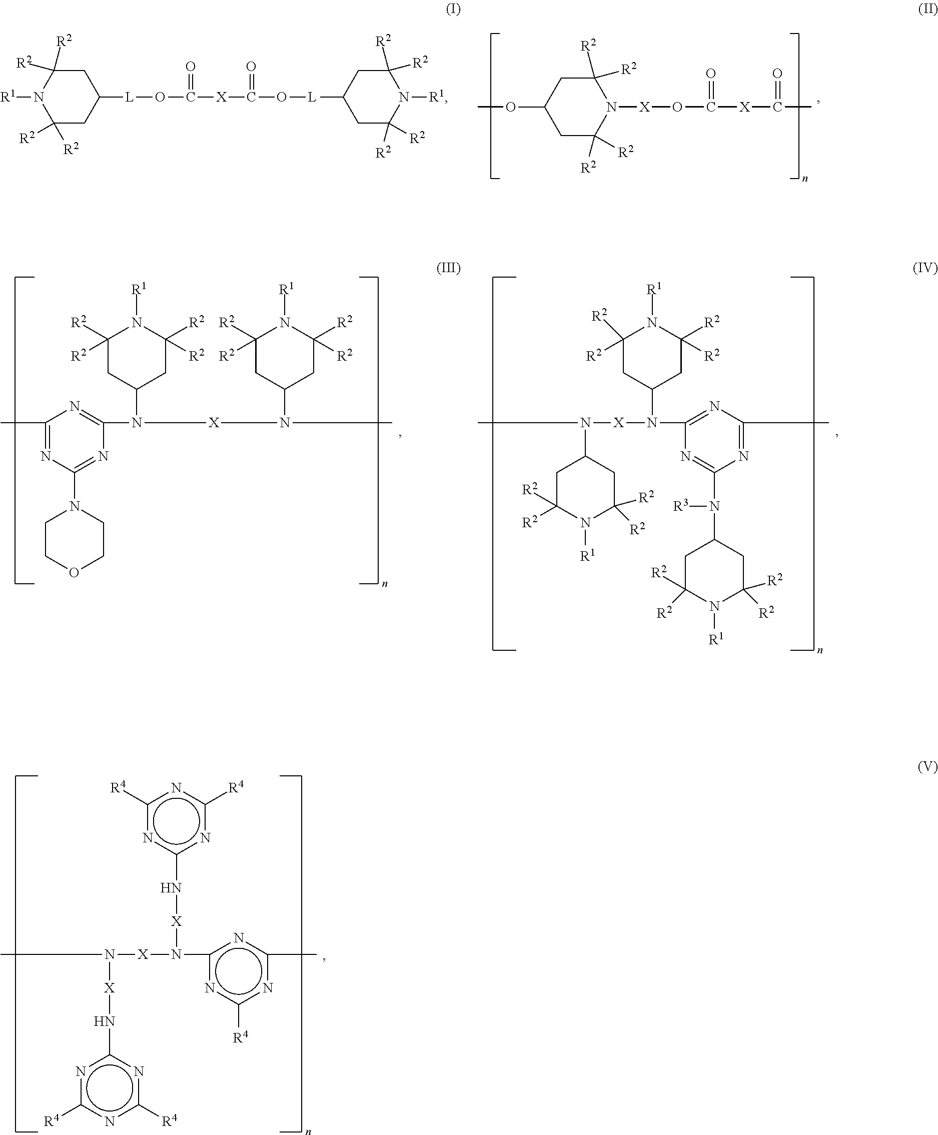 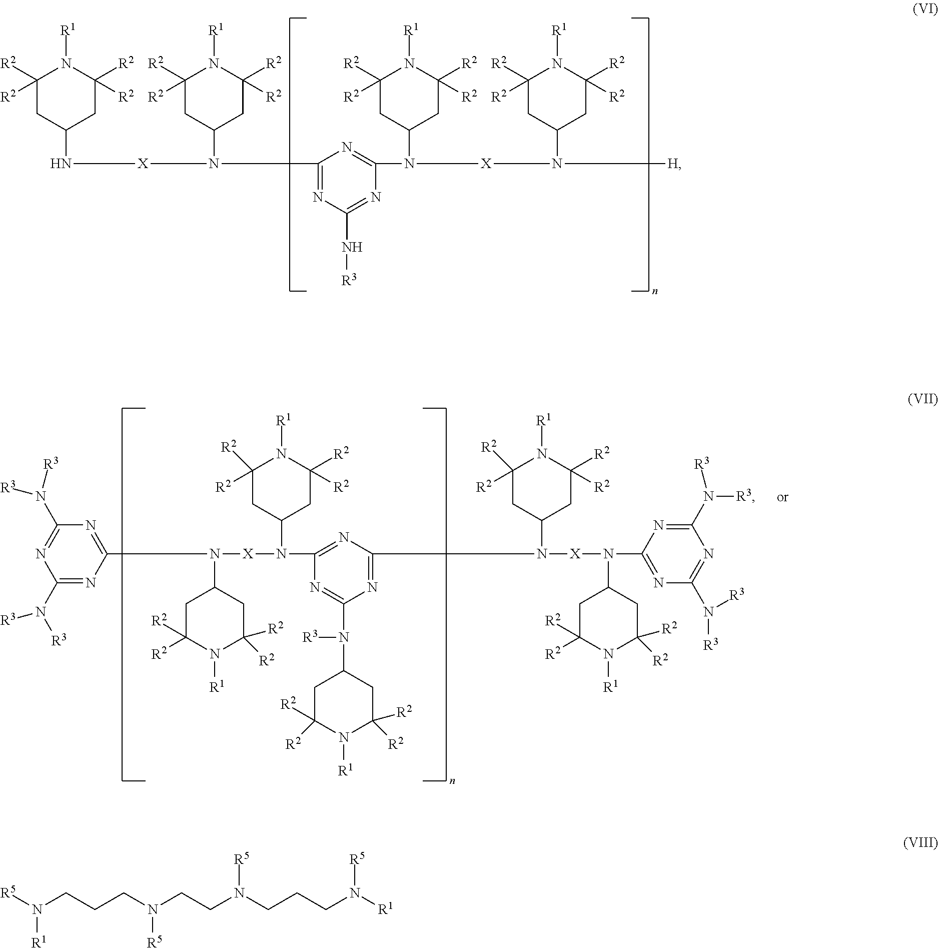
wherein:
each X is independently selected from the group consisting of C1-C20 alkyl and C1-C20 alkenyl;
L, in each instance, is absent or is independently selected from the group consisting of C1-C20 alkyl and C1-C20 alkenyl;
each R¹ is independently selected from the group consisting of hydrogen, C1-C20 alkyl, C1-C20 alkenyl, —O(C1-C20 alkyl), and —O(C1-C20 alkenyl);
each R² is independently selected from the group consisting of hydrogen, C1-C20 alkyl, and C1-C20 alkenyl;
each R³ is independently selected from the group consisting of hydrogen, C1-C20 alkyl, and C1-C20 alkenyl;
each R⁴, if present, independently has a structure of: 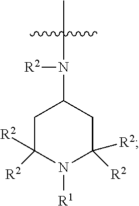
each R⁵, if present, independently has a structure of: 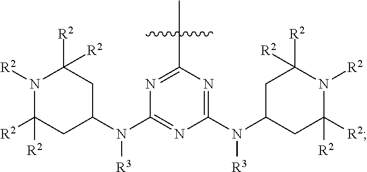
and
n is an integer selected from 1 to 10, 20, 50, 100, 1,000, or 1,000,000.

16. The acrylic fiber of claim 15, wherein each R¹ is hydrogen.

17. The acrylic fiber of claim 15, wherein the hindered amine light stabilizer has a structure of Formula VI, VII, or VIII.

18.-19. (canceled)

20. The acrylic fiber of claim 1, wherein the acrylic fiber is unpigmented.

21. The acrylic fiber of claim 1, further comprising a pigment.

22.-27. (canceled)

28. The acrylic fiber of claim 1, wherein the acrylic fiber is in the form of a fabric that has no tear strength loss or a tear strength loss in the warp and/or fill direction of less than about 50% after exposure to about 800 kJ to about 2500 kJ in accordance with AATCC 169 Option 3.

29.-35. (canceled)

36. A method of preparing an acrylic fiber, the method comprising:
combining a hindered amine light stabilizer and a poly(acrylonitrile-co-methyl acrylate) to provide a stabilized poly(acrylonitrile-co-methyl acrylate) composition; and
forming an acrylic fiber from the stabilized poly(acrylonitrile-co-methyl acrylate) composition, extruding, etc. the stabilized poly(acrylonitrile-co-methyl acrylate) composition), thereby preparing the acrylic fiber.

37.-46. (canceled)

47. An article comprising an acrylic fiber of claim 1.
